(19) United States
(12) Patent Application Publication
(10) Pub. No.: US 2023/0128945 A1
(43) Pub. Date: Apr. 27, 2023

(54) Systems And Methods for Monetization of Time and Activity on a Digital Ledger

(71) Applicant: Burkhan LLC, Bethesda, MD (US)

(72) Inventor: Shahal Khan, Washington, DC (US)

(21) Appl. No.: 17/729,669

(22) Filed: Apr. 26, 2022

Related U.S. Application Data
(60) Provisional application No. 63/272,369, filed on Oct. 27, 2021.

(51) Int. Cl. G06Q 30/02; G06Q 20/06; G06Q 20/36; G06Q 20/38

(52) U.S. Cl. CPC G06Q 30/0239; G06Q 20/065; G06Q 20/3678; G06Q 20/3821; G06Q 20/381

(57) ABSTRACT

Systems and methods for creating an economic system and associated processes to enable earning of income in a local currency based on time invested in activities conducted on-line. This permits people in locations with few conventional ways to earn income to be compensated for the value they add to others by spending their time and devoting their attention to activities they can pursue from their location. These activities may include various forms of participating in gamified activities in which credits are earned for performing certain on-line tasks, assisting themself or others to achieve a goal, etc. The earned credits may be exchanged for a “token” whose value is determined by the economic system being disclosed, and which can be exchanged for local currency.

### CROSS REFERENCE TO RELATED APPLICATION

This application claims the benefit of U.S. Provisional Application No. 63/272,369, entitled “Systems And Methods For Monetizing Investment of Time in an Activity,” filed Oct. 27, 2021, the disclosure of which is incorporated, in its entirety (including the Appendices) by this reference.

### BACKGROUND

It is estimated that there are two billion people in the world without access to banking services. Further, nearly half of the global population lives in what is considered poverty by Western standards and have no clear path to earning a sustainable income. This puts these people at a distinct disadvantage when it comes to participating in the opportunities provided by the world economy, much less being able to generate sufficient income to survive and provide for their families.

In addition, due to the COVID-19 crisis, governments are burdened with a level of debt that is likely to cause rapid inflation as well as pressures to grow capital markets to sustain growth. At the same time, poorer economies are being impacted by the threat of inflation as geo-political factors take control of supply chains. In response to these possible causes of financial instability, there is little many people can do to take control of their ability to earn with a level of compensation at least equal to their need to survive and provide for others, let alone thrive.

Overall, there is risk and inequality in global economic markets and a real lack of opportunity for many on the lower end of the economic scale. This suggests the desirability of a new economic model based on a different view of labor that will allow income to be generated and wealth to be distributed through a more transparent system based on the true value of work or time invested. It also suggests the desirability of an economic system that cannot be corrupted or controlled by a central entity that defines value in terms of performing labor and investing time in what someone else requires for payment to a person performing the work.

Embodiments of the systems and methods described herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter described in this document, the drawings or figures, and to the claims. Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments described herein are directed to a system and methods for creating an economic system and associated processes to enable people to earn income in their local currency based on time they invest in activities they conduct on-line. This permits people in locations with few, if any, conventional ways to earn income to be compensated for the value they add to others by spending their time and devoting their attention to activities they can pursue from their location. In some embodiments, these activities may include various forms of participating in gamified activities in which credits are earned for performing certain on-line tasks, assisting themself or others to achieve a goal, etc. In some embodiments, the earned credits may be exchanged for a “token” whose value is determined by the economic system being disclosed, and which can be exchanged for local currency.

Today, the human energy spent on social platforms and engaging with a variety of technologies and applications creates monetizable value in the form of data. The data generated is not just from spending time scrolling, but also from the actions one chooses to take while scrolling—these actions may include “likes”, comments, reports, clicking to access a website, etc. This type of human interaction is referred to as engagement.

Unfortunately, and for most social media platforms, users earn no compensation for the energy they put into engaging with the platforms. And yet, it is this engagement and interaction that gives these platforms a substantial part of their value. Instead, users and their actions are “mined” for their data and the platforms received economic compensation for providing that data to others for serving advertisements or using it to provide value to others.

In contrast, the economic model and system disclosed herein (referred to herein as the TEMPUS network or an engagement network) accounts for that time and energy by compensating the work done by the users who give their attention to create valuable data and information. In some embodiments, this is through the ability to earn what is referred to herein as a “KAIROS TOKEN” or token. From one perspective the token represents the TEMPUS network's point or reward system and is a measure or reflection of the “value” of a user's engagement time, activities, and generated data that is earned by the user.

The economic model created by the TEMPUS network commodifies people's time and enables them to augment their incomes by earning compensation for their engagement with platforms they enjoy, typically (although not exclusively) through gamification of an activity. The TEMPUS network is one approach to envisioning a world where all people, regardless of their educational levels, position in society, or location can obtain value for their invested time and effort. Examples of activities that may be encouraged or incentivized by the TEMPUS network include but are not limited to planting a tree, reducing pollution, encouraging recycling, reducing hunger, encouraging an educational experience, or other desirable goal. The TEMPUS network enables a person to participate in pursuing a desirable goal while earning a return on their invested time and effort using an existing service platform or one that is built in response to a desire by a group of people to collaborate to solve a problem or achieve a goal. The value of each participant's sweat equity is determined based on the time they have spent, their experience, and their contribution to the goal, and is generated as an asset of the TEMPUS network.

In one embodiment, the disclosure is directed to a method for creating an economic system and associated processes to enable people to earn income in their local currency from time they invest in activities they conduct on-line.

In some embodiments, this may include the creation or use of existing indicators of user interaction with content, or a user performing an action and may be captured as data or parameters of a ledger stored on a blockchain¹. In some embodiments, the indicators are data reflecting a user's interaction with an object and/or creation of external connections with the engagement network. The external connections may arise from interacting with social media outside of the engagement network and may identify the social media platform and/or a specific user through links (such as hashtags or other forms of identifiers). Such indicators/identifiers may be used to trace engagement activities of others that result from a user's activity and to allocate additional tokens to the user because of the value they create indirectly through the engagement and actions of others. ¹ A blockchain is a decentralized and distributed digital ledger consisting of records (blocks) and is used to record transactions across multiple computers. One feature of a blockchain is that a block cannot be altered retroactively, without causing an alteration of all subsequent blocks. This allows the participants to verify and audit transactions independently and inexpensively in terms of the resources required. Blockchains allow secure, distributed storage of event and transaction data that is verifiable and resistant to unauthorized usage.

The blocks in a blockchain are interconnected by encrypting data of a previous block in the chain and inserting it into a current block. Each block contains a cryptographic hash of the previous block, a time stamp, and exchange information (such as conditions on when a payment will be transferred, or a condition satisfied—a form of “smart” contract). A blockchain database is managed autonomously using a peer-to-peer network and a distributed timestamping server. New blocks are authenticated by mass collaboration powered by collective self-interest. This approach facilitates workflow and one where participants' uncertainty regarding data security is reduced to an acceptable level, thereby engendering sufficient trust to engage in economic transactions. One reason for this is that the use of a blockchain removes the characteristic of unauthorized reproducibility from a digital asset by confirming that each unit of value was transferred only once, solving the long-standing problem of double spending.
Blockchain-based smart contracts are proposed contracts that can be partially or fully executed or enforced without human interaction. A key feature of smart contracts is that they do not need a trusted third party (such as a trustee) to act as an intermediary between contracting entities. Instead, the blockchain network executes the contract on its own. See Wikipedia entry for Blockchain.

Examples of the creation of value are the creation of objects, NFTs (non-fungible tokens), or replications of physical objects in the Metaverse, where a user is given compensation to interact with the Metaverse and a separate value is associated with the activity or type of interaction. As mentioned, the indicators/identifiers also enable further “downstream” or “second order” engagement value caused by a user to be valued and allocated to the total value associated with the user's identity, in addition to the time the user interacted or engaged with the original activity or content.

In one embodiment, the value of a user's engagement and activities will be determined, at least in part, by the measurement and processing of tele-metrics data (described in greater detail in the following) stored in a time related database. In one embodiment, disclosed method may include the following steps, stages, functions, processes, or operations:
Establish, create, or define interactions (such as behaviors, actions, etc.) that facilitate engagement—in some embodiments, this may include “Gamification” of participation in an environment or activity, or otherwise creating incentives for a user to achieve a goal by enabling acquisition of tokens as a reward for engagement and/or accomplishing a task;
   The “goal” may include one or more of the following:
      Winning a game;
      Finishing a project;
      Contributing to the improvement of a situation;
      Encouraging a desired behavior;
   The tokens (referred to as the Kairos token herein) may be transferred to a user as a reward or payment for one or more of performing a task on-line, providing information or personal data, contributing to a discussion, assisting in resolving a problem, generating a review of a product, etc.;
      In general, an entity may choose to reward a user for accomplishing a task they want to encourage and use the Tempus network to facilitate the desired behavior and the Kairos tokens as a form of incentive/payment; Provide Users with an Engagement Environment and Tools with which to Acquire Token(s)
Based on the type, level, or degree of Engagement;
   This may include providing a website within the Tempus network to which a user can navigate to be provided with an opportunity to earn tokens;
      The user may be provided with tools or task descriptions to inform them of how they may earn tokens, such as by performing a specific task, contributing content, completing a stage in a project, etc.;
The Tempus system/platform Tracks User Time Spent and Actions Taken/Tasks Performed in the Environment;
   The tracked data provides the inputs to a model, rule-set, formula, or calculation that determines the number of tokens earned by a user for a specific task or contribution;
      In some embodiments, the model, rule-set, formula, or calculation may be provided by the operator of the disclosed engagement network;
         In some embodiments, a baseline model, rule-set, formula, or calculation may be modified by a “host” of the activity that a user is earning tokens by becoming engaged with or performing;
      In some embodiments, the model, rule-set, formula, or calculation may be varied over time based on an interest in creating incentives for specific behaviors by users (as determined by a trained model, etc.);
As an example, Based on Time Spent by a User, Actions Taken, and Reputational Status of the User, Determine or Calculate the Value of Tokens Earned by the User;
   The method of determining the tokens earned by a user may comprise use of a trained model, a rule-set, a formula, or other applicable methodology;
      As a non-liming example, the number of tokens earned by a user may be a function of one or more of:
         Time spent;
         User reputation or experience level;
         User stake in tokens/native crypto-currency;
         A base award for an action or task;
         User location;
         A bonus offered by the entity incentivizing the behavior;
   In general, user behaviors that may be used to determine the number of tokens a user earns may be based on one or more of:
      Initial value of the user's time to be connected to the network (a basic engagement value), based on a monetary value of a minimum wage in their location/country and a “true” cost of living represented as a compensation per second of their connectivity to the system;
      Interaction or activity within the engagement network, through gamification (with increased compensation based on their activity and reputational score as recorded in the parameter/blockchain ledger); and
      Post event engagement by generation of data connected to the original platform through interrelation of links on third party media platforms, thereby increasing engagement beyond engagement with the original platform (example: messaging, talking, or promoting the original event on third party social media platforms with hash tags connected to the original gamified event and engagement network so total influence can be tracked, measured, and compensated in terms of a network effect);
Transfer Earned Tokens to a Secure Digital Asset “Wallet” of a User; Allow Conversion of Tokens Earned and Stored in Wallet to a Native (Platform-Specific)
Crypto-Currency (referred to as the Tempus coin or coin herein);
Enable Exchange of Native Crypto-Currency to a Suitable Local Currency and/or Other
Crypto-Currencies; Use a Portion of Tokens Earned by Users to Support Valuation of the Native Crypto-Currency;
   This may be achieved by the user converting earned tokens that are “internal to the system” or on-chain to the “external” or off-chain Tempus coin (the native crypto-currency of the engagement network). The tokens that reflect the value of a user's interactions are saved on the blockchain (“on-chain”), along with any additional value created by second or higher order engagements and activities of others caused by the user's initial engagement and activity;
      Such indirect, second order, or high order engagements represent the impact of a user on the engagement and activities of others in the network, and provide a mechanism for rewarding a user for the value others create because of the user's engagement and activities;
   In one embodiment, half of the user's total compensation is saved onto their internal token wallet. The other half is attributed to the Tempus network balance sheet, which is also maintained on the on-chain internal platform. Once the tokens have reached a timeframe set within their specific code that allows them to be able to become liquid and exchangeable for fiat currencies or other modes of exchange, they will be able to be transferred through a hybrid wallet;
      In some embodiments, a hybrid wallet is a combination of a software wallet (stored on a user's own computer) and a web wallet (stored on a third-party server) that can convert crypto currencies to fiat currencies. This wallet forms a closed payments ecosystem allowing for instant transfers settlements between the wallets and associated cards;
      In some embodiments, the proportion of a user's earned tokens that are attributed to the user compared to the proportion allocated to the network balance sheet may differ from the example given and may depend upon one or more factors, where these factors may include:
         Total amount or degree of engagement by the user;
         Change in amount or degree of engagement by the user over time;
         Accomplishment of a specific task;
         Amount of second or higher order (i.e., indirect) engagement(s) by others caused by user or resulting from user activities;
   Tokens may be converted to a native crypto-currency (the Tempus coin) and placed on an off-chain exchange to be traded for fiat or other crypto-currencies or traded within an external platform connected to the engagement network (typically on a peer-to-peer basis). Tokens may also be held by a user and earn interest within the internal system as well as be used to earn higher levels of ranking within the system based on the total number of tokens earned;
      The system may be implemented as a level of participation and success-based system where total time spent in engagement and activities and engagement level will be accrued over time—this will allow for the per second compensation to be increased as the level of participation and influence of a user increases over time;
      As the tokens may be created in an almost infinite number, the number of coins held on the engagement network balance sheet and those available on the market will be controlled to produce price inflation of the native crypto-currency on the open exchange market;
         The market and its pricing will be controlled by the token economics of the platform treasury, whereas the coins used for retail purchase transactions will be eliminated from the ledger and those coins that are in the open exchange that can be traded will only be fully liquid after a 90-day period to be able to trade or convert to other currencies (fiat or other digital currencies). Coins and/or tokens held in private wallets and not placed on open exchanges will earn an interest rate, thus creating incentives for saving and a disincentive for spending. The total amount of tokens saved provides a measure of a net worth of a user and can be linked to their generated or related data and/or to their “reputational score”, and can be a value which they can use to create additional financial tools and assets, such as the ability to borrow against their personal balance sheet or trade and swap for goods; and
Create incentives for Users to Retain Ownership of Tokens to Support Valuation of the Native Crypto-Currency. Examples of incentives include but are not limited to:
   Earning Interest on the Tokens not used;
   Increasing levels of reputational score tied to increased compensation per second and determined by the total amount of tokens earned as well as amount of time saving those tokens;
   Creation of ability to borrow against the Tokens saved;
   Ability to bank without any fees; and
   Ability to have access to education, healthcare, property mortgages and other asset-based loans based on total number of tokens in an account.

In one embodiment, the disclosure is directed to a system for creating an economic system and associated processes to enable people to earn income in their local currency from time they invest in activities they conduct on-line. The system may include a set of computer-executable instructions and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to a set of computer-executable instructions, wherein when the set of instructions are executed by an electronic processor or co-processors, the processor or co-processors (or a device of which they are part) perform a set of operations that implement an embodiment of the disclosed method or methods.

In some embodiments, the systems and methods described herein may provide services through a SaaS or multi-tenant platform. The platform provides access to multiple entities, each with a separate account and associated data storage. Each account may correspond to a user, set of users, an entity offering users an opportunity to earn tokens, a set or category of entities, a set or category of users (such as a family, club, etc.), a set or category of opportunities to earn tokens (improving the environment, games, or reducing hunger, as examples), or an organization, for example. Each account may access one or more services, a set of which are instantiated in their account, and which implement one or more of the methods or functions described herein.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1 is a flowchart or flow diagram illustrating a method, process, set of operations, or set of functions for implementing and operating an economic system and associated processes to enable people to earn income in their local currency from time they invest in activities they conduct on-line, in accordance with some embodiments;

FIG. 2 is a diagram illustrating elements or components that may be present in a computer device, server, or system configured to implement a method, process, function, or operation in accordance with some embodiments;

FIG. 3 is a diagram illustrating an eco-system formed around and including the engagement network disclosed herein;

FIG. 4 is a diagram illustrating integration of a native crypto-currency with the other elements and features of the engagement network and eco-system disclosed herein;

FIG. 5 is a diagram illustrating an example of a marketplace eco-system or architecture that implements an embodiment of the systems and methods disclosed herein;

FIG. 6 is a diagram illustrating an eco-system comprising the disclosed engagement network and a plurality of external connected devices or systems, in accordance with an embodiment of the systems and methods disclosed herein;

FIG. 7 is a diagram illustrating elements, components, or processes that may be implemented as part of an engagement network eco-system, in accordance with an embodiment of the systems and methods disclosed herein;

FIG. 8 is a diagram illustrating a processing flow for a payment transaction using the native crypto-currency and engagement network disclosed herein;

FIG. 9 is a diagram illustrating examples of one or more external systems, devices, or processes that may be integrated with an embodiment of the engagement network disclosed herein;

FIGS. 10(a) and 10(b) are diagrams illustrating an example of the integration of one or more external systems, devices, or processes with an embodiment of the engagement network disclosed herein;

FIG. 11 is a diagram illustrating an example architecture for integrating an engagement engine with other elements, components, or processes in an embodiment of the engagement network disclosed herein;

FIG. 12 is a diagram illustrating an architecture for segmenting users of an engagement network based on collected data regarding user engagements and activities, in accordance with an embodiment of the systems and methods disclosed herein;

FIG. 13 is a diagram illustrating elements, components, or processes that may be implemented as part of a user engagement data analytics model, in accordance with an embodiment of the systems and methods disclosed herein;

FIG. 14 is a diagram illustrating an example architecture and relationships between elements, components, or processes implemented as part of an engagement network and external elements, components, or processes that form part of an engagement network eco-system, in accordance with an embodiment of the systems and methods disclosed herein;

FIG. 15 to FIG. 20 are diagrams illustrating aspects of the discussion of game and player data, metrics, and analytics and the significance of those to game development, game publishing, and game revenue as an example of a use case of the disclosed systems and methods;

FIG. 21(a) is a diagram illustrating a data interface that may be used to collect data programmed into a WEB 3.0 or metaverse type setting, in accordance with an embodiment of the systems and methods disclosed herein;

FIGS. 21(b) through 21(e) are diagrams illustrating how a user's action and engagement in a gamified and/or metaverse environment for a specific task is processed by the Tempus network technology, in accordance with an embodiment of the systems and methods disclosed herein;

FIG. 22 is a diagram illustrating certain of the functions involved in the collection and analysis of engagement data in a gaming environment, and an example of the inputs or factors that may be part of each function, in accordance with some embodiments; and

FIG. 23 is a diagram illustrating aspects of the data acquisition and pre-processing that may be part of an implementation of an embodiment.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems and methods described herein may provide services through a SaaS or multi-tenant platform. The platform provides access to multiple entities, each with a separate account and associated data storage. Each account may correspond to a user, set of users, an entity offering users an opportunity to earn tokens, a set or category of entities, a set or category of users (such as a family, club, etc.), a set or category of opportunities to earn tokens, or an organization, for example. Each account may access one or more services, a set of which are instantiated in their account, and which implement one or more of the methods or functions described herein.

As used herein, the terms “Engagement Network”, “Tempus Network”, and “Tempus” refer to elements, components, and processes that form a system or platform for assisting users to earn credits for behaviors and activities involving their direct engagement with websites, the performance of tasks, the generation of data, or similar actions. A user may also earn credits for the value they create indirectly by causing engagement and activities by others. As used herein, the terms “Kairos Token”, “Kairos” and “Token” refer to the credits earned by a user for their direct engagement and the value they create indirectly. As used herein, the terms “Tempus Coin”, “Coin”, and “Native Crypto-Currency” refer to a form of crypto-currency issued by the Engagement Network, and which in one example may be acquired in exchange for tokens.

The KAIROS token creates a form of compensation for a user's engagement, actions, generated data, and the value of those to an entity. This is different from loyalty or other models, as those approaches are not able to measure the total value created by a person's attention or engagement in a specific process or action within a digital environment in real time. Further, those approaches and systems are unable to measure the value created after completion of a user's actions (the indirect or so-called “butterfly effect”) and measure the engagement value of the data generated by additional participants brought into the engagement “universe” based on the first action. As a result, the reward available to people from conventional approaches is not sufficient to hold their attention for long or allow them any benefit other than from a direct transaction.

In contrast, a function of the described token is to more accurately compensate people based on the total value they create through their attention, generated data, activities, and influence on others (which represents an indirect or higher order effect). The described engagement network achieves this by placing the revenue usually kept by third party social media platforms “behind” the tokens, thereby compensating users on the platform for engaging and more accurately reflecting the value they create by their engagement time, activities, generated data, and influence on the engagement of others.

The tokens earned by a user (which reflect the value of their engagement time, activities, and generated data) may be determined using a rule-set, formula, algorithm, or trained model. The rule-set, formula, algorithm, or trained model may be defined or generated by an operator of the engagement network and/or an entity seeking to incentivize users of the network to engage with their content or perform a specific activity. The earned tokens are recorded in a database stored on a blockchain. When an individual wants to liquidate their tokens, the tokens can be converted to a native crypto-currency (the TEMPUS coin). The native crypto-currency can then be used to purchase other crypto-currencies and/or fiat currencies through an exchange.

In some embodiments, a goal of the TEMPUS or engagement network is to enable a form of economy, based at least in part on a person's “reputation score”. In this context, Reputationalism™² is based on Capitalism economic principles but encourages engagement and tracks the value of a person's engagement using blockchain stored data and reputation scores. An implementation of Reputationalism as an economic framework may utilize a DMOS (Data Management Operating System) platform that is designed to secure and control the distribution of data from the perspective of an identity, where an identity can be a corporation, a group, or an individual. ² In the context of the disclosure, Reputationalism is based on the identity of the individual as a core feature. An aspect of Reputationalism is the intrinsic control of currency and information by a person, or by a defined group (e.g., family, social, religious, ethnic, etc.). A goal is for individuals to retain full access to their own data, and to be able to control and limit who receives access to their data. Revoking access, after grant, will ensure that the shared data is removed and no longer accessible to an entity it was shared with.

In some embodiments, and in the context of the system and platform disclosed, a DMOS is a platform that enables the data collected within a gamified environment to be routed and stored in structured and unstructured data formats for different (and often unique) use cases. The data can be ingested, processed, routed, analyzed, and stored as log data for each user and associated with their digital identity. This centralizing of generated data is not only for purposes of efficiency, but also important to controlling how the generated data is linked to the personal identity of a user and enabling access to the true value of the data created.

In some embodiments, the data management operating system (DMOS) collects raw behavioral data from users and uses the disclosed artificial intelligence and modeling techniques to convert that data into structured and more useable data that can be used to establish a trend line and serve as a measurement tool. In one embodiment, the DMOS is an API (application programming interface) engine that uses the HTTP (hypertext protocol) to transmit messages. The DMOS may be a library implemented in C++ that provides client-side functionality and a backend for storing the data using PHP/My SQL, Oracle, and an Apache server. Using HTTP allows for system communication cross platforms and integration and development, with the assumption of an existing network connection and network handling within the operating systems.

To use the DMOS system, a developer or programmer uses a C++ header “game metrics”, and a second header “game defaults” containing the enumerated types and labels describing the events to be logged. The header is included by the game or platform programmer and is loaded as part of the game metrics.

In one embodiment, game metrics as part of the DMOS operation may be setup in the following sequence:

1. Program telemetrics into the game to pixelate content;
2. Initialize the game system content to connect to the platform AI system;
3. Check Auth with USER ID;
4. Open session with Unique for that time period;
5. Register version number with time value added and connected to the specific platform database of measurement;
6. Get game parameters;
7. Start play session;
8. While game is live log events; and
9. Close session end time when finished.

These metrics or parameter values are quantitative measures of attributes of objects and movements of a specific user within a gaming or social platform and can be observed and measured. As disclosed herein, a useful source of game tele-metrics is user behavior. This data can be used in the form of raw metrics such as total playtime and daily active users. However, the disclosed systems and methods (such as the DMOS) go deeper into the measurement of player behavior (for example, in the metaverse of Web 3.0 environments) by looking at touch points, interactions, and the indirect impact of players/users through programmed analytics. This enables the development of business intelligence for identifying, extracting, and analyzing user data during both live interactions and post participation by a user or group. This data is monetizable through direct valuation of the data and the relationships (expressed in one embodiment in monetization tables) within the DMOS to which the collected data is correlated.

In one embodiment, monetization tables in the DMOS are databases containing data that is purchased by third parties and have a market value determined by past sales on platforms such as Google or Facebook. Interaction databases may define a certain amount of value for a user based on their location and value per hour of compensation based on their skill level, and this information is also stored in the DMOS system. The DMOS may incorporate measurements or evaluations of users based on experimental psychology, computational intelligence, machine learning, and human-computer interaction to evaluate how well people play and engage in a gamified environment.

As an example, a user's Avatar may earn more points for achieving a level in a game or where hits or misses can be measured, and that effort can be attached to an increased level of performance (for example, by representing the performance as a value measured from 0-100, where 0 is no compensation per time monetary value earned and as levels of performance increase the value of time spent and monetary compensation increases. In the long term, players and engagers with higher data metrics will earn more; as an example, a user with more followers and who is able to maintain larger engagement and create a more extensive indirect (butterfly) effect will create a larger sequence of data in the DMOS, and thus have a greater reputational score.

In some embodiments, the concept of Reputationalism provides a basis for developing an infrastructure and associated processes/features to enable the creation of an economic system. These features or capabilities may include:
1. Currency within the system will be crypto-currency based. The currency may be issued by a Government, corporation, or an individual. For example, a celebrity may give out “engagement tokens” to fans for use internal to their own community, or an eCommerce type of company using its own currency to drive commerce and economy through dealing with consumers and suppliers with its own defined and measured reputational score system;
   a. The creation and distribution of tokens may be motivated by one of the goals described or by a desire to motivate a different behavior. Regardless, the creator or distributor may implement a rule-set or formula to determine how to compensate a person in tokens based on that person's reputation, type of engagement, indirect value created, etc.;
2. The central “bank” in the disclosed model is a cloud-based exchange. Other exchanges can be operated on the Reputationalism infrastructure, allowing for the creation of multiple banks each with its own set of benefits and features;
3. Reputationalism as referred to herein provides additional security and accountability. In some embodiments, its implementation may utilize an irrefutable database ledger on a blockchain in order derive a score connected to a user's identity. This enables a level of trust to be created between users and creators of the data. It also provides a level playing field for people to derive income that is tied to creation of actions on social networks and on digital platforms. In this way, it is similar to the way Capitalism creates laws and regulations to attempt to level the playing field for corporations based on trust and by indicating behaviors that will lower a credit score (as an example) based on actions defined as (or otherwise considered) wrong or inappropriate by the community;
   a. In some embodiments, Reputationalism may take the form of a set of control parameters set for a gamification network that will add value to a user's profile, or delete value based on what that system believes or “learns” are positive or negative actions or behaviors. These actions or behaviors may be defined in terms of tele-metric parameters within the database and measured through artificial and biometric systems tied to a user's identity and profile;
   b. For example, gameplay metrics that can increase or decrease a user's earning or value may be dependent on the total amount of interaction the player has within the game, both with the platform and with other players/users. For example, combat or collaboration through game mechanics, in-game chat, sending messages hash-tagged to certain brands or some combination thereof, or posting to a social media platform chat such as META, may contribute in one way or another to the “value” of a user's/player's data;
   c. In one embodiment, information about a player and their actions that can impact their score, or the value of their data may be reflected by responses to one or more of the following questions:
      i. What are they doing?;
      ii. What are they affecting;
      iii. What are they causing?;
      iv. Who are they affecting?;
      v. What Group are they affecting?; or
      vi. What is a measure of that group's retention and response?
         Note that parameters for the gain or loss of a value can be set up specifically for each platform and instance, as some actions deemed negative in one gamified environment may not be negative in others. Further, in some embodiments, the value of data generated by these actions or behaviors may be determined by a rule-set, formula, or trained model, where these evaluation approaches may be based on actual data values obtained from social networks or data warehouses, for example.
In one embodiment, the gameplay metrics collected may include:
   a. Points scored;
   b. Song/Track Chosen;
   c. Match with Rhythm/Auditory mechanics of the display or experience;
   d. Difficulty setting;
   e. Track the user's actions that can be rewarded;
4. Track user actions that can diminish their score (i.e., a negative action as programmed into or defined by the system);
5. In the way that proven expertise or reputation can garner higher income for an individual, a Reputation Score will provide a natural conduit for capable and reputable individuals to be able to earn more value in terms of tokens and crypto-currency; and
6. A benefit of the disclosed system is that the reputation score of an individual (or an entity) will require less proof of work, stake, or authority. This creates a positive reinforcement system to incentivize “good” Reputational behavior, and a punitive response for untoward, fraudulent, or illegal behavior;
   a. In this regard, conventional blockchain-based systems of currency and compensation using hive-based systems of data analysis have a proof of work feature based on a computer system completing a transaction on a ledger or a proof of stake feature which is that a user has invested a sufficient sum of currency within a system. In contrast, Reputationalism is based on the increase of a person's user value and data value based on the person's score and quality of data created by their own actions.

In addition to the social and economic benefits, the concept of Reputationalism enables infrastructure benefits by improving the performance of systems that utilize blockchain. In this regard, benefits may include creation of a Hierarchy of Trust or HoT. The Hierarchy of Trust creates an environment that benefits from the features of:
Zero-knowledge—even though cloud-based, there is no way for a person or entity to access to a user's data/currency without that user's explicit authorization;
Fully GDPR (or other privacy related requirement) compliant today—meets the most rigid of privacy criteria;
Provides a mechanism for users to be able to get paid for the sharing of their data even under GDPR regulations; this is a benefit given the risk involved for GDPR non-compliance. Corporations are expected to dramatically reshape or eliminate much of their user data collection which has an immediate negative revenue impact for multiple channels;
Provides a mechanism that allows users to control their personal data, whether financial, health, career or hobby-related; and
Incorporation of Quantum Proof encryption and the use of true Quantum Tokens. The tokens will be used not only for the cryptocurrency aspect but for identity tokens as well as linking identities e.g., families;
   Where here, quantum based refers to the actions and algorithms being used in environments based on the sheer volume of data that will be created.

As described, Reputationalism is designed around the identity of the individual as a core tenet. This includes an ability for individuals to retain full access to their own data without limit, and conversely to be able to control and limit who gets access to their data. Providing control and access rights will be simple and easy to accomplish. Similarly, revoking access, after granted, will ensure that the shared data is truly removed and no longer accessible to the entity it was shared with.

As disclosed, in some embodiments, the value of the activity performed, data created, and time spent by a user is assessed and transferred to the user through the KAIROS token. The KAIROS token allocates a value to a user's participation as determined by an engagement algorithm, rule-set, model, or formula, with the engagement data and tokens earned contained in a database on a blockchain. When an individual wants to “liquidate” or convert their time spent on a platform represented as tokens, it is monetized through the value of the native crypto-currency on a decentralized crypto-currency exchange where it will be listed. Note that this approach is different from loyalty, affinity, or other models, as they are not able to measure the total value of a person's attention or engagement and convert that to a form in which it may be used as a currency.

A function of the disclosed token is to measure and compensate people more accurately based on the value of the activities they perform, the data their activities create, and the time they spend engaged. Compensation may be earned at income levels that allow people participating to recognize long term value. The disclosed engagement network achieves this by placing revenue typically kept by third party social media platforms behind the tokens, and compensating users for engaging on a per hour basis that may increase based on their level and type of engagement.

Behind (i.e., supporting) the engagement network's native crypto-currency and the disclosed earn-for-engagement model is a DeFi (decentralized finance) network in the form of a hybrid digital wallet that enables conversion of earned tokens into TEMPUS coin (i.e., the network's native cryptocurrency), and enables a user to keep the native crypto-currency or transfer its value into local (fiat) currency. In some embodiments, users can trade rewards, mint NFTs, exchange with other cryptocurrencies, or spend their TEMPUS coin via conventional payment gateways such as Visa, Mastercard, or similar networks.

In some embodiments, a base value of the native crypto-currency may be determined from two sources:
The monetizable value that brands, social platforms, and organizations gain from engagement by or with their target audience;
   this may include both value directly resulting from a user's actions and value generated indirectly from the actions of others that are in some way caused or encouraged by the user's actions; and
The added value of effort made by the person that is engaging with a platform or activity;
   For example, jumping, level progression, speed of achieving a goal or scoring, abilities used, enemy performance, damage taken, sources of damage, can all be used as factors in determining value and can be programmed into an environment of gaming as events that are captured by game metrics. Further examples may include character Avatar progression, quest completions, quest times, Avatar ability to use instructions, interactions within team, or win-loss ratios within simulations. The measurement of the time a player is engaged in a game or activity is placed within the value of a TIME parameter, and the user's time and data/work value are based on the disclosed economic model of engagement, where an Avatar is incentivized to act and interact rather than sit sedentary on a platform for hours without movement or engagement;
   In one embodiment, this base value may be determined by the following equation or formula, where the factors, variables, or parameters are a Person's identity (PI), the Person's data makeup (DM), the Geographical residence (GM), the Cost of living (real in data) (CL), the Value of data generated over time (VL), the Numerical sale value of that data (VS), ties into Action in a digital world (touch, movement) (AC), and a Measurement of the “butterfly effect” based on indirect or follow on engagement by others (BE):

(PI+DM+GM+CL)=((VL*VS*AC)*BE)

As described, valuation of the native crypto-currency is based (at least in part) on the relationship behind a theoretically infinite number of tokens that may be generated in comparison with a limited amount of investable native crypto-currency on the market. In one embodiment, all coins that are used for economic transactions are “burned” (i.e., destroyed, rendered valueless), while those held for trading and storage of earned value will be limited in number, thereby creating a long-term pricing scarcity. This arrangement assists in creating a “market” for the native crypto-currency and supporting its value.

Digital currency scarcity is a concept that addresses the limitation of resources in digital format and that is related to blockchain technology and the maintenance of its decentralized economic system. A fixed-supply scarcity is valued because it is coupled with accelerating demand, proven use cases, and recognized desirability. The disclosed TEMPUS coins will have a scarcity element tied to them as there will be a limited amount that will be allowed at any time to be on a public exchange as traded coins.

The disclosed TEMPUS (engagement) network provides direct remuneration for user engagement, representing a reversal of the conventional model, which has taken engagement and monetized it for its own revenue through advertising. As described, the engagement network may utilize blockchain technology and provide an immutable record of all user engagement, with the user's time and activities becoming monetizable and a value linked to each user. Users may sell or exchange their native crypto-currency and receive local currency for their engagement efforts.

In one scenario, the network may begin with an existing activity (such as gaming) and expand into other contexts, such as converting into gamification of sectors such as education, entertainment, charity, etc. In each context, a goal is to encourage participation by rewarding engagement with tokens that are exchangeable for local currency.

In some embodiments, the disclosed engagement network incorporates a system and methods of verification and audit that do not rely on the conventional blockchain verification infrastructure and maintains the blockchain audit trail. In some embodiments, the disclosed engagement network may address security and privacy concerns through a key-based security process that is associated with a user's identity on the blockchain. In this example, the “key” is a cryptographic digital ID that is associated with a user's identity. As some (if not all) game and tele-metric data collection may be considered confidential, data access, transfer, and transfer of results should be stored in secure servers and tied to keys, so the stored data can only be accessed by authorized users. This will help to prevent manipulation of the system or earning mechanisms.

Note that blockchain is a data ledger, but that the disclosed systems and methods tie a data ledger to a value pricing matrix to generate and store the value of the data and tie it to an identity as a form of currency. A user's digital identity enables use of digital technologies to share pieces of personal information, typically termed attributes. This gives users control over how much and which pieces of information are shared. The identity is protected behind a user avatar and is anonymous to veil a person's characteristics (such as ethnic, racial, or cultural makeup of the person), and instead it is their digital identity that is verified and assessed.

While brand engagement is one area in which the disclosed engagement network may disrupt conventional approaches, the gamification of users' engagement time and activities will also have an impact on gaming, education, and labor. This is because the engagement network “makes a market” between crypto-currencies (via the TEMPUS coin) and other virtual currencies through its own over the counter (OTC) exchange that will be attractive to both players and publishers for use in games (as an example). The engagement network also provides an inventory of coins that creates a balance sheet for market making, which is connected to the value of the number of coins available to the market.

As an example, when a holder of earned tokens wants to cash out one or more tokens, they transfer/convert an amount of tokens into the native crypto-currency through their wallet. In one embodiment, the engagement network's automated market maker executes the transaction without a fee, instead using collateral and inventory assets while keeping an inventory of assets with which the platform can generate revenue. The native crypto-currency can also be used to purchase crypto-currencies and other tokens in bulk and provides liquidity to holders of tokens interested in transacting with other users.

Crypto market-making involves providing liquidity on a defined cryptocurrency by submitting both bid and ask limit orders on a crypto exchange. A market maker participates in the securities market by providing trading services for investors and boosting liquidity in the market. They provide bids and offers for a particular security in addition to its market size. Through transaction fees, the disclosed TEMPUS platform benefits from every transaction that is enabled between two or more actors to monetize the data into fiat currency form or in its native currency.

The disclosed platform may charge a spread on the buy and sell price and transact on both sides of the market as it is creating, measuring, and valuing the data and currency based on the total market size of its balance sheet. This because the amount of data created directly correlates to the number of coins generated and issued, as well as to the total value of those coins. In an arbitrage model, the platform sponsor (TEMPUS) exploits a widely separated relationship between actors on the platform, often associated with physical products, and creates its own position controlling access to and between the actors. The arbitrage model actively contributes to maintaining a position of control to the extent that the platform takes on not only an orchestrating but also a price-setting role by acting as an intermediary.

The disclosed engagement network addresses the liquidity and compliance concerns of conventional crypto assets by the integration of a dual crypto/fiat wallet. The use of Layer 2 blockchains, which enable transactions to occur faster and with lower costs than Layer 1 blockchains, will further support liquidity and enable transactions to settle seamlessly from a user's point of view. Token assets will transfer in substantially real time, in the same way that digital goods and virtual currencies operate.

In conventional social media and gaming platforms, money and time are spent, not invested. In contrast, the disclosed engagement network allows digital assets purchased in a game to be retained as real property and transferred, as opposed to losing all value the moment a purchase is made. However, game or content publishers want to avoid the destabilization of their game economy and player engagement once they have built a successful platform, and this concern creates a hesitation to make changes to the gaming asset economy. In this regard, integration of the disclosed engagement network provides a low-risk, highly-compliant approach to the tokenization of gaming, allowing existing games to scale their implementation of NFT and blockchain technologies while allowing gamers to earn extra income in the form of tokens.

To maintain security and privacy, in some embodiments, the engagement network may utilize multiple levels or categories of verification and access control. For example, users seeking to earn compensation for their engagement and activities may be required to provide information equivalent to a “know your customer” (KYC) model, at least on a first “level”. The first level of access control (termed Level One) may enable users to earn tokens from gaming or activity platforms connected to the engagement network. As an example, Level One access may require a user to submit a username, password, and email address.

To convert the earned engagement tokens to crypto-currency, hold or trade commodity tokens/stable-coins, make a withdrawal, or sell their crypto-currency, users may be required to provide additional information. For example, these actions may require a higher level of verification, termed Level Two verification, which may (for example) require proof of address, ID card verification, and facial verification.

Similarly, users interested in opening an engagement network “bank” account may be required to satisfy Level Three verification. In addition to Level Two requirements, such users may be required to submit proof of AML (anti-money laundering services or procedures) and source of funds. If users are interested in investing in security tokens, they may be required to prove investor qualification to achieve Level Four status.

In some embodiments, tokens are created/minted as money flows into the balance sheet of the engagement network, with a portion of advertiser money “minted” into tokens. The remainder of incoming money is distributed to the engagement network to grow the balance sheet and reward the stakers of the native crypto-currency coins. As described, users of the network platform may earn tokens through their engagement with advertisers, brands, and other organizations' content. The number of tokens they earn may be dependent on location, user reputation, and time spent engaging or participating in activities, among other possible factors.

The disclosed platform captures value by accessing the tele-metric granular data tied to each specific user ID and their actions, as those are defined as being of value in a gamified platform. The platform thereby enables third parties to access relevant information about each user. The use of data monetization for value capture results in the value potentially increasing with the increasing richness and relevance of the collected data. Further, the data generated from interactions and transactions between users may define trends that were not previously analyzed and valued (such as challenges or unique interactions within a gaming environment or task-focused environment or experience).

Users in possession of tokens may spend their tokens on discounted products and services offered internally by the engagement network or convert their tokens into the native crypto-currency for use outside of the engagement network. In some embodiments, users may earn interest on tokens held within the network's wallet.

When a user earns enough tokens (which may depend on the token to coin conversion rate and may vary over time), they may convert tokens into the native crypto-currency by sending their tokens to a provided address to be “burned”. When the engagement network receives confirmation of the transaction, the network may use the balance sheet value of the burned tokens to purchase the native crypto-currency at market value and transfer ownership of those to the user. This interaction/transaction is automated and may be implemented using “smart” contracts.

While decentralized finance (DeFi) is currently a significant smart contract market, developers are increasingly building fraudproof, crypto-economically incentivized gaming applications. One of the characteristics of blockchain games is their ability to generate rare tokenized in-game items (mostly in the form of non-fungible tokens, NFTs) which become smart receipts, as the blockchain provides definite proof of the item's rarity.

Minting these items in a manner that the external entities or the game's developers can manipulate to their advantage is key to ensuring their value, which is why a secure and provably fair source of Random Number Generation (RNG) is used (which generates on-chain cryptographic proofs to prove to users that the randomness was not tampered with). The assumed fairness of this form of randomness brings reliability to the rarity of items, thereby creating opportunities such as the virtual metaverse where tokenized items can be used across different games.

Verifiable randomness is also used to establish unquestioned fairness in regulated gambling applications, thereby removing the need to trust that “the house” is telling the truth about the odds. Beyond randomness, gaming environments can benefit from numerous data sets, such as real-world event data to augment in-game functions/ratings, exchange rates to facilitate NFT markets, IoT data to connect the physical world on-chain, and more. In-game purchasable items are a component of most games, as they provide users with special powers or unique attributes. Many in-game items are issued as (NFTs), a token that is unique and not interchangeable. The disclosed platform, through its verification of user's creation of data, can be used to generate provably random NFTs and create NFT attributes as rewards for different predefined in-game achievements.

In some embodiments, the native crypto-currency may be “staked” for a reward. Staked coins may earn a percentage of the brand and advertising money that flows through the engagement network's balance sheet.

As described, tokens are earned through user engagement and activities. These activities include, but are not limited to money spent, time spent, geo-presence, the viewing of advertisements, time using applications, etc. User engagement and activity data is collected by the network and stored on a blockchain. In one sense, the token is used as a means of payment by brands to reward desirable engagement with their activities, content, games, etc.

The token is the basic form of payment for engagement-related earnings by a user and is stored in a wallet associated with the user. In some situations, the engagement network may want to incentivize users to lock/hold tokens in their accounts, as a decrease in available crypto-currency on the open market will drive an increase in the value of the token and crypto-currency. Further, locking tokens in the network's wallet may allow a user to stake their tokens and earn interest, thereby incentivizing the user to hold the tokens which, in turn, drives up the value of the token.

The following sections provide additional details regarding the implementation and operation of the (Tempus) engagement network and the associated (Kairos) tokens and native crypto-currency (Tempus coin).

### (KAIROS) Tokens and Native Crypto-Currency (Tempus Coin)

1. The number or amount of tokens earned by a user for (a) initial engagement and/or (b) user activities may be determined by a rule, formula, trained model etc., and may be a function of one or more characteristics or parameters. As a non-limiting example, an algorithm or formula for payment may include one or more of the following parameters:
   user average income per hour (based on location, user demographic data) times;
   user interaction with brand's value times;
   total number of hours engaged times;
   premium level (or multiplier) paid per minute for gameplay or social interactions;
In some embodiments, the rule, formula, or trained model may be provided by the engagement network/platform operator, while in others it may be provided by the entity seeking to incentivize a user (e.g., a game operator, business, brand, charitable organization, school, or sports team);
2. The value earned by a user through their engagement and activities are paid into a wallet account containing (KAIROS) tokens;
3. The disclosed engagement network incorporates two primary economic elements or functions:
   a (KAIROS) token for internal network transactions; and
   a (TEMPUS coin) native crypto-currency for use within the network banking eco-system and that is transferable to other crypto-currencies or fiat currencies based on the market value of the native coin as traded on one or more crypto exchanges;
      As described, one aspect of the native crypto-currency is the relationship behind a large number of tokens generated by user engagement and activities versus a limited number of native crypto-currency coins available on the market. In theory, the value of the engagement network balance sheet will continue to grow both the value of the token and coin, but the number of coins available on the market will be limited. This is expected to create a pricing mechanism through scarcity;
4. (TEMPUS) Crypto-currency coin: in some embodiments, the number of coins in circulation may be capped, for example at 33,000,000,000 in circulation;
   a. Fractal of 9 decimals—this allows the currency to be broken down into smaller portions for exchange;
5. (KAIROS) Tokens are held in DeFi wallets and can earn interest;
6. (TEMPUS) Crypto-currency coins can be bought on exchanges or earned in exchange for (KAIROS) tokens;
7. In some embodiments, a holding period may be required when buyers earn (KAIROS) tokens before the tokens can be converted to (TEMPUS) native crypto-currency coins;
   This holding period may be used to prevent speculation and moderate changes to the coins available on the market;
      In one embodiment, the holding period may be a term of 5 days, 10 days, 15 days, one month, etc.;
   In one embodiment, there may be a separate holding period before a user may convert a Tempus coin into another crypto-currency or fiat currency (e.g., a longer and possible multiple of the token holding period);
8. (KAIROS) Tokens that are used within the closed loop system of the engagement network are “burned”/destroyed for their balance sheet value; and
9. Once converted to a native crypto-currency coin, a token cannot be burned—this further ensures that a limited number of coins are made available on the open exchanges.

Earning (KAIROS) Tokens

In one embodiment, and as a non-limiting example, users may be able to earn tokens by the following two categories of behaviors:
Banking Engagement:
   1. Receiving welcome bonuses for opening a wallet (e.g., 100 tokens);
   2. Completing a user profile;
   3. Completing a set of KYC verification requirements; and
   4. Users with at least a specified number of tokens in their wallet (e.g., 100 tokens, 1000 tokens, 5000 tokens) may receive additional levels of discounts and rates on referrals;
User Engagement/Activities:
   1. Online:
      a. Shopping, watching videos, answering surveys, interacting with advertisements, writing reviews;
      b. Downloading applications, spending time using apps, playing mobile games;
   2. Offline:
      a. Finding offers, providing proof of receipts to satisfy offers;
      b. Checking-in at stores/time spent in store;
      c. Sale of quality user-made product photos to brands social media for reuse;
   3. Data:
      a. Content generation: photos of product/sale advertisement and submission to marketplace;
      b. User feedback on products;
   4. Affiliate program:
      a. Receive token rewards for affiliates (e.g., from 5% to 20% of client fee);
   5. Merchants and chat administrators may choose to receive tokens as part of the revenue from their sales and pay less in commission.

Determining the Number of Tokens Earned for User Engagement

As mentioned, the amount or number of tokens earned by a user for their engagement with a platform, website, game, task, project, etc. and/or due to performing an activity associated with one of these contexts may be determined by a rule-set, formula, trained model, or other suitable technique. The trained model may (as an example) generate an output corresponding to the number of tokens earned based on user engagement history, user activities, or other features and be intended to provide an award to the user that has been found to be sufficient to incentivize a desired action.

In some embodiments, the rule-set, formula, trained model, or other suitable technique may be defined by an administrator or manager of the platform, website, game, task, or project. The amount or number of tokens earned may be comprised of two components: (a) a first amount or number based on visiting a website or registering for a project, and (b) a second amount or number for performing a specific activity or taking a specific action. The rule-set, formula, algorithm, trained model, or other suitable technique may generate a constant value or may be a function of time, the user's total number of tokens, the user's total number of coins, or other factor(s).

In some embodiments, the value or number of tokens earned by a user may be a function of one or more factors or characteristics. In one non-limiting example, the number of tokens earned is the product of three factors: a user reputation Score, a user stake score, and a baseline award for the action. Each of these three example factors are described in greater detail below.
Reputation Score—this is a quantitative measure of brand influence, obtained from user social influence and economic behavior (purchasing power). The score is normalized against other user's reputation(s). It can be >1 (bonus award) as well as <1 (discounted award);
   Reputation scores may be based on a 5-star-index, such as that used by some online platforms. Note that behavioral trustworthiness is not a static or binary value but can be dynamic and non-discrete and evaluating it can be subjective. Hence, a player in a game who has behaved more reliably in the past does not necessarily continue to do so in the same way, and this will affect their score;
   Reputationalism may use an AI-based engine to distinguish between trust as an attitude and trusting behavior. According to this differentiation, a higher reputation score can positively influence our trusting beliefs, but reputation might be too low to pass the threshold of trusting behavior (i.e., to trigger a purchase decision and money transfer). Trust situations are framed as sales transactions between a buyer (trustor) and a seller (trustee). Instead of exchanging actual goods, participants are told that they can earn or loose monetary equivalents of goods depending on the action of a participant in a game. Decisions that may determine or impact a reputational score in a gamified environment may be stored as values of either “1” (act) or “0” (not act);
Stake Score—this is a quantitative measure of a premium a user receives because of the amount and locked duration of holding KAIROS tokens by that user. The score is normalized against other users staking behavior. It can be >1 (bonus award) as well as <1 (discounted award); and
Base award for the target action—this is a nominal (face value) award or factor for an initial engagement action or behavior by the user.
   As described, in some embodiments, the engagement formula is intended to motivate users to build their reputation with the engagement network, as well as to stake more tokens to leverage their score and receive a larger award for an action a user is completing.

In another non-limiting example, the amount or number of tokens earned by a user may be determined by a greater number of factors or characteristics. For example, the following may each be used as part of a rule-set, formula, or model to determine multiplicative or additive terms that result in a total number of tokens earned by a user:
1. Person's identity;
2. Person's data makeup;
3. Geographical residence;
4. Cost of living (real in data);
5. Value of data generated over time;
6. Numerical sale value of that data;
7. Ties into action in digital world (touch, movement);
8. Measurement of second or higher order impact based on follow on engagement s and activities by others.

User engagement is a quality of user experience characterized by the depth of the user's investment when interacting with a digital system. Engagement is more than user satisfaction: it is believed that the ability to engage and sustain engagement in digital environments can result in positive outcomes for citizen inquiry and participation. User engagement may be characterized by the depth of an actor's cognitive, temporal, affective and behavioural investment when interacting with a digital system. A range of methodological approaches have been utilized to measure engagement, including behavioural metrics such as web page visits and dwell time, neurophysiological techniques such as eye tracking and electrodermal activity (EDA), and self-reports verbal elicitation and message activity.

As described, once tokens have been earned, they may be exchanged for the native crypto-currency (Tempus coins). The tokens or coins may be spent in one or more of several ways and may receive preferential treatment by merchants or organizations that are part of the network. As examples, services paid for with tokens or the native crypto-currency may be purchased at a discounted price, services and products may be purchased within the network using tools provided in the network, etc.

The value across all Engage-to-Earn games comes from the currency that players earn within the platform, based at least in part on the amount of time a user invests in a game, its popularity, and the demand for the in-game assets or underlying tokens. For mobile games this may entail paying to stop seeing advertisements in a game, and for computer or video games it may involve new content. For example, a loyal player might choose to buy an expansion pack that includes new furniture or themes. Expansion packs often cost less than a full game, but the user needs the full game to access them. This is a form of in-game currency, money that is connected to a certain game. A user typically exchanges real money for in-game currency, like markers at a casino. In-game currency typically cannot be exchanged for real money. The disclosed platform changes that dynamic by allowing the TEMPUS coin to be exchanged for real currency.

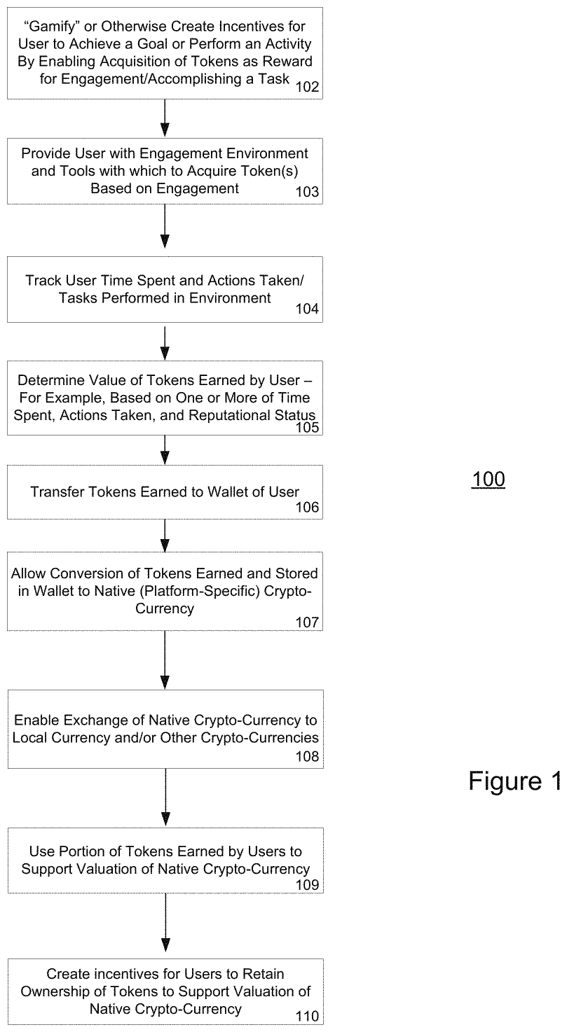

FIG. 1 is a flowchart or flow diagram illustrating a method, process, set of operations, or set of functions 100 for implementing and operating an economic system and associated processes to enable people to earn income in their local currency from time they invest in activities they conduct on-line, in accordance with some embodiments. As shown in the figure, an embodiment may implement the following steps or stages, typically by executing a set of computer-executable instructions, some of which may be executed in a client device and some in a remote server platform:
“Gamify” or Otherwise Create Incentives for User to Achieve a Goal or Perform an Activity By Enabling Acquisition of Tokens as Reward for Engagement/Accomplishing a Task (as suggested by step or stage 102);
   As non-limiting examples, the “goal” or task may include one or more of the following:
      Winning a game;
      Finishing a project;
      Contributing to the improvement of a situation;
      Reducing pollution;
      Informing people about an issue;
   The tokens (referred to as the Kairos token herein) may be transferred to a user (that is, the tokens are associated with the user's account/identity) as a reward or payment for performing a task on-line, providing information or personal data, contributing to a discussion, assisting in resolving a problem, generating a review of a product, etc.;
      In general, an entity may choose to reward a user for accomplishing a task they want to incentivize and use the Tempus network to facilitate the desired behavior and the Kairos token as a form of payment;
         As non-limiting examples, such an entity may be a sports team, a school, an on-line gaming operator, a charitable organization, etc.;
Provide User with Engagement Environment and Tools with which to Acquire Token(s) Based on Engagement (as suggested by step or stage 103);
   This may include providing a website within the Tempus network to which a user can navigate to be provided with an opportunity to earn tokens;
      The user may be provided with tools or task descriptions to inform them of how they may earn tokens, such as by performing a specific task, contributing content, etc.;
The Tempus system/platform Tracks User Time Spent and Actions Taken/Tasks Performed in the Environment (as suggested by step or stage 104);
   The tracked data provides the inputs to a model, formula, or calculation that determines the number of tokens earned by a user for a specific task or contribution;
      The tracked data may be stored on a blockchain and associated with the user;
Determine Value of Tokens Earned by User—For Example, Based on One or More of Time Spent, Actions Taken, and Reputational Status (as suggested by step or stage 105);
   The method of determining the tokens earned by a user may comprise use of a trained model, rule-set, formula, or other applicable methodology;
   As a non-liming example, the number of tokens earned may be a function of one or more of:
      Time spent;
      User reputation or experience;
      User stake in tokens/native crypto-currency;
      A base award for an action or task;
      User location;
      A bonus offered by the entity incentivizing the behavior;
Transfer Tokens Earned to (Secure) Wallet of User (as suggested by step or stage 106);
   The wallet may be stored on the user device or stored elsewhere and made accessible to the user through a secure access process;
Allow Conversion of Tokens Earned and Stored in Wallet to a Native (Tempus Platform-Specific) Crypto-Currency (referred to as the Tempus coin herein, as suggested by step or stage 107);
   This conversion may be based on a conversion “rate” which is a function of when a token was earned, how it was earned, the number of tokens in circulation, the number of coins in circulation, etc.;
      For example, the value may be based on taking the total market value of the coin and dividing it by the number of coins in circulation on the public exchanges;
Enable Exchange of Native Crypto-Currency to Local Currency and/or Other Crypto-Currencies (as suggested by step or stage 108);
   This may be facilitated by links to crypto exchanges, etc.;
Use Portion of Tokens Earned by Users to Support Valuation of Native Crypto-Currency (as suggested by step or stage 109);
   This may be achieved by allowing a user to only convert a portion of the Kairos Tokens they have earned into Tempus coins. The Token(s) that assign a value to the user's interactions are saved on the blockchain, along with any additional value created by second or higher order effects of their engagement and actions (that is, indirect effects that generate engagement or increased engagement by others);
      In one embodiment, a 50% of user's total compensation in tokens is saved onto their internal token wallet. The other 50% is attributed to the Tempus network balance sheet, and recorded the blockchain;
      Once the Tokens have been held long enough to satisfy the holding period defined within their specific code (for example, 5 days, 10 days, 15 days, one month, etc.), they become “liquid” and transferable to (able to be converted into) native crypto-currency (Tempus coins), fiat currencies, or other modes of exchange via transfer through a user's wallet;
         The disclosed Tempus network will set the time a token can be placed on the public network—this may be based on the total amount of TEMPUS coins on the exchange that are allowed, and the holding float period of the Kairos token to be fulfilled. This holding period is designed to allow sufficient cash and collateral to be built in the TEMPUS network treasury to allow for balance of payments “reserves” to accumulate;
         In another embodiment, the proportion of earned tokens allocated to the user's wallet may differ, with a corresponding difference in the proportion allocated to the platform balance sheet (e.g., 70/30 with 70% allocated to the user, 60/40, etc.);
      Tokens may be converted to native crypto-currency and placed on an off-chain exchange to be traded for fiat or other crypto currencies or may be traded within an external platform connected to the engagement network on a peer-to-peer basis. Tokens may also be retained by a user and earn interest within the internal system, as well as be used to earn higher levels or multipliers within the system based on total tokens earned;
      In some embodiments, the per engagement, activity or time-based compensation in tokens may be increased as the level of participation and influence of a user increases over time;
      As the tokens will be (potentially) infinite in number, processes within the engagement network may adjust the number of native crypto-currency coins held on the network balance sheet and those available on the market to stimulate price inflation of the coin on the open exchange market; and
Create incentives for Users to Retain Ownership of Tokens to Support Valuation of the Native Crypto-Currency (as suggested by step or stage 110). Examples of incentives include but are not limited to:
   Earning interest on tokens not exchanged for coins;
   Increasing levels of reputational score (causing increased compensation per engagement time, for example) based on total amount of tokens earned as well as length of time holding those tokens;
   Creation of ability to borrow against the tokens saved;
   Ability to “bank” coins without fees; and
   Ability to access educational or healthcare services or obtain mortgages or other asset-based loans based on total tokens in a user's account.
      Note that the order of steps or stages 109 and 110 may be changed if, in an embodiment, it is desired to first create an incentive for a user to retain earned tokens (that is, to not convert a portion of their earned tokens into the native crypto-currency or other form of currency) and then use the retained tokens as a mechanism to support the valuation of the native crypto-currency. In most embodiments, both step or stage 109 and step or stage 110 may be occurring concurrently.

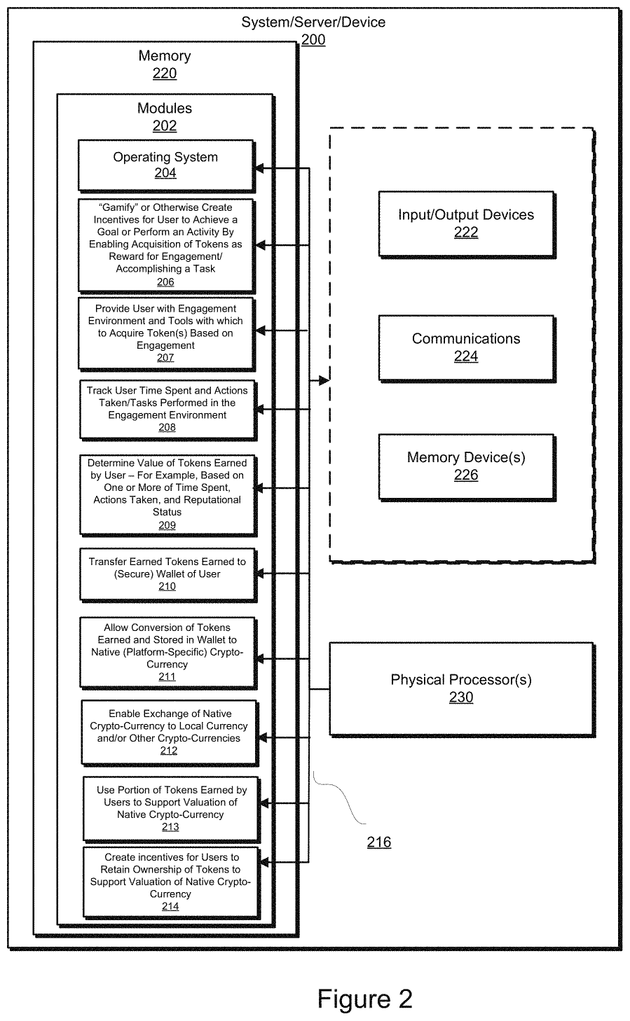

FIG. 2 is a diagram illustrating elements, components, or processes that may be present in or executed by one or more of a computing device, server, platform, or system 200 configured to implement a method, process, function, or operation in accordance with some embodiments. In some embodiments, the disclosed system and methods may be implemented in the form of an apparatus or apparatuses (such as a server that is part of a system or platform, a client device, etc.) that includes a processing element and a set of executable instructions. The executable instructions may be part of a software application (or applications) and arranged into a software architecture.

In general, an embodiment of the disclosure may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent one or more of a server, client device, platform, or other form of computing or data processing device. Modules 202 each contain a set of executable instructions, where when the set of instructions is executed by a suitable electronic processor (such as that indicated in the figure by “Physical Processor(s) 230”), system (or server, or device) 200 operates to perform a specific process, operation, function, or method.

Modules 202 may contain one or more sets of instructions for performing a method or function described with reference to the Figures, and the descriptions of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the co-processors may be contained in different devices, for example a processor in a client device and a processor in a server.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing instructions. Bus or communications line 216 also permits processor(s) 230 to interact with other elements of system 200, such as input or output devices 222, communications elements 224 for exchanging data and information with devices external to system 200, and additional memory devices 226.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation. As mentioned, an apparatus in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed system and methods, such as for:
“Gamify” or Otherwise Create Incentives for User to Achieve a Goal or Perform an Activity By Enabling Acquisition of Tokens as Reward for Engagement/Accomplishing a Task (as suggested by module 206);
Provide User with Engagement Environment and Tools with which to Acquire Token(s) Based on Engagement (module 207);
Track User Time Spent and Actions Taken/Tasks Performed in the Engagement Environment (module 208);
Determine Value of Tokens Earned by User—For Example, Based on One or More of Time Spent, Actions Taken, and Reputational Status (module 209);
Transfer Earned Tokens Earned to (Secure) Wallet of User (module 210);
Allow Conversion of Tokens Earned and Stored in Wallet to Native (Platform-Specific) Crypto-Currency (module 211);
Enable Exchange of Native Crypto-Currency to Local Currency and/or Other Crypto-Currencies (module 212);
Use Portion of Tokens Earned by Users to Support Valuation of Native Crypto-Currency (module 213); and
Create incentives for Users to Retain Ownership of Tokens to Support Valuation of Native Crypto-Currency (module 214).

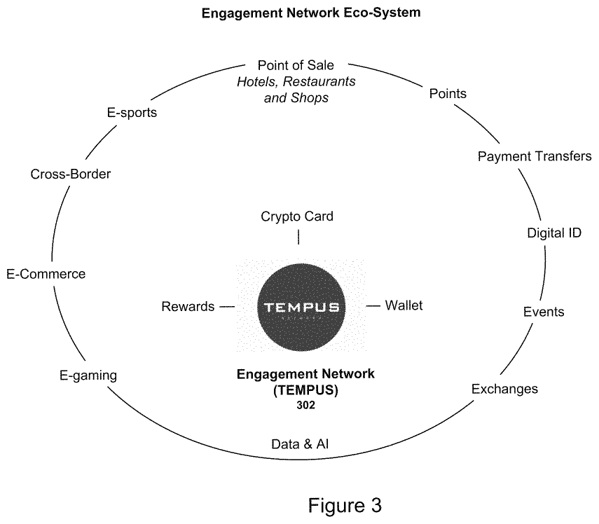

FIG. 3 is a diagram illustrating an example eco-system formed around and including the engagement network disclosed herein. As suggested by the figure, the Tempus engagement network 302 may comprise elements, components, or processes that include a Rewards for Engagement 304 functionality, a Crypto Card 306 functionality (a debit card that has connectivity with the payment rails of the traditional global banking system), and a Wallet 308 functionality. Engagement network 302 may be connected with or otherwise able to interact with one or more of:
Point of sale networks located at hotels, restaurants, shops, etc.;
Points or awards storage elements for awards earned from other systems, loyalty programs, etc.;
Payment transfer networks or systems to enable purchase or use of engagement network coins for conducting transactions;
Digital identification processes, data, and storage elements used to identify individual users for purposes of authentication and tracking a user's engagement and activities within network 302;
Events or activities that a user can engage with or participate in, such as E-sports or associated networks, E-gaming or associated networks;
Networks or processes to enable E-commerce transactions, transactions with crypto-exchanges, Cross-border transactions, etc.
   The above list represents examples of the types or categories of elements, components, processes, or networks that an engagement network 302 may connect to and interact with to provide services to users. The list is for example purposes and is not intended to be comprehensive or otherwise liming.

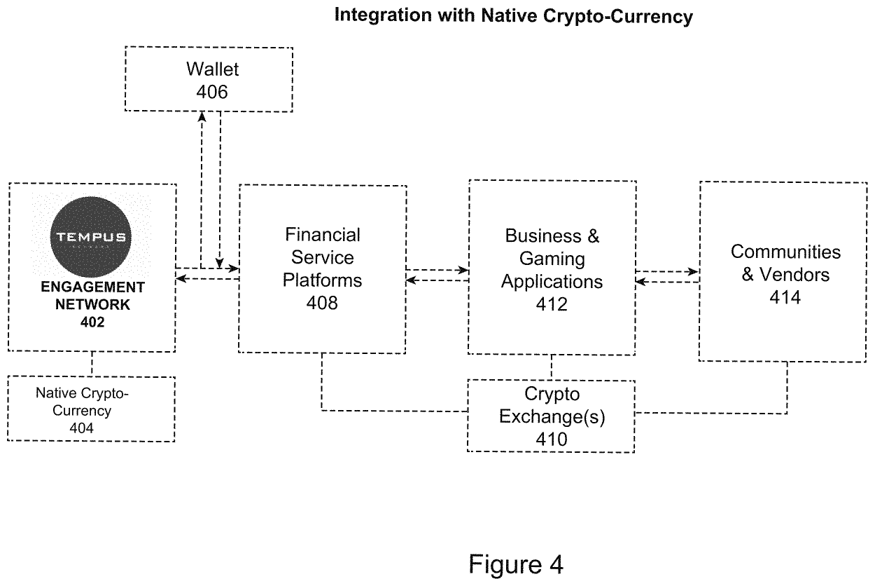

FIG. 4 is a diagram illustrating integration of a native crypto-currency (i.e., the Tempus coin) with the other elements and features of the engagement network and eco-system disclosed herein. As shown in the figure, engagement network 402 may interact with a native crypto-currency store 404 to enable users to exchange earned engagement tokens for the native crypto-currency. A user's earned tokens and native-crypto-currency may be stored in a Wallet 406. Engagement Network 402 may interact with Financial Service Platforms 408 to facilitate the processing of transactions between a user and other entities, such as by enabling an exchange of a user's native crypto-currency for another crypto-currency (using a Crypto-Exchange 410), and payment to a desired application or service platform (such as those suggested by Business & Gaming Applications 412). Communities and Vendors 414 represents other sets of users or service providers that may integrate with an application or service 412 and thereby enable a user to participate in a community or obtain a desired service or product.

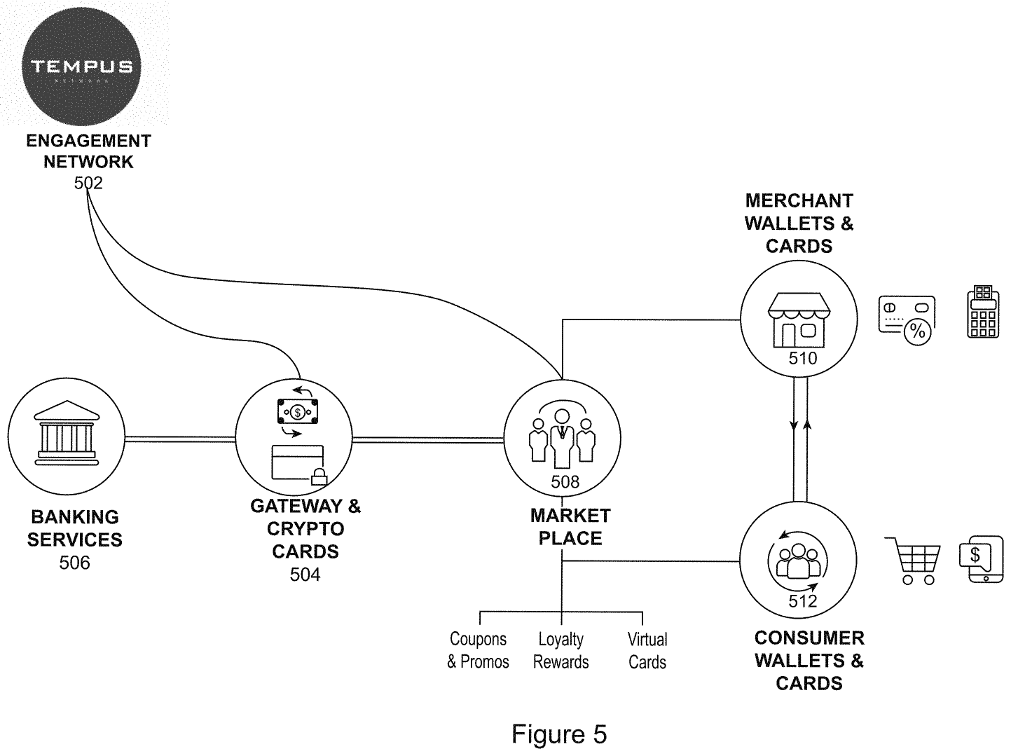

FIG. 5 is a diagram illustrating an example of a marketplace eco-system or architecture that implements an embodiment of the systems and methods disclosed herein. As shown in the figure, an engagement network 502 may be connected to (and/or integrated with) other elements, components, or processes to provide am operating marketplace for participants in network 502 to use earned tokens and native crypto-currency to make purchases or products and services. In one example, engagement network 502 may be integrated and/or connected to a gateway server and crypto-currency storage cards 504. Gateway server and crypto-currency storage cards 504 are connected and able to exchange data and information with banking services 506 and a marketplace 508 to enable participants in network 502 to use marketplace 508 to identify and products and services of interest and conduct transactions. As suggested by the figure, marketplace 508 may include functionality to enable a user to take advantage of promotional offers, coupons, loyalty program rewards, and virtual cards, among other functions. Consumer digital wallets and cards 510 and merchant digital wallets and cards 512 may be connected to marketplace 508 and to each other to enable a consumer to engage in transactions for a merchant's products and services after the consumer identifies its desired purchase.

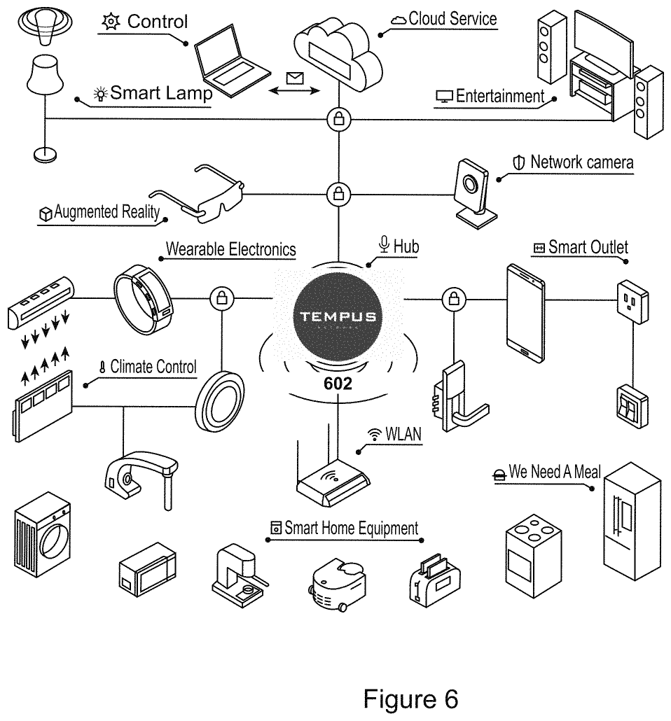

FIG. 6 is a diagram illustrating an eco-system comprising the disclosed engagement network and a plurality of external connected devices or systems, in accordance with an embodiment of the systems and methods disclosed herein. As shown in the figure, an engagement network 602 may be connected to or otherwise able to interact with multiple types of devices and processes. These devices and processes may include, but are not limited to or required to include those shown:
“smart” devices (e.g., lamps, electrical outlets, home thermostat control); cloud-based services;
augmented reality devices;
a camera;
entertainment devices;
a local network appliance;
wearable devices; or
a router.
   The ability of network 602 to be integrated with and/or connected to such devices and processes can assist both participants in network 602 earning regards for engagement as well as organizations who are encouraging engagement activities. Participants can connect with embedded devices and applications, while organizations can be provided access to data (in some cases anonymized to protect privacy and data security) for purposes of segmenting users, training machine learning models, or other uses that better enable the organizations to encourage engagement activities.

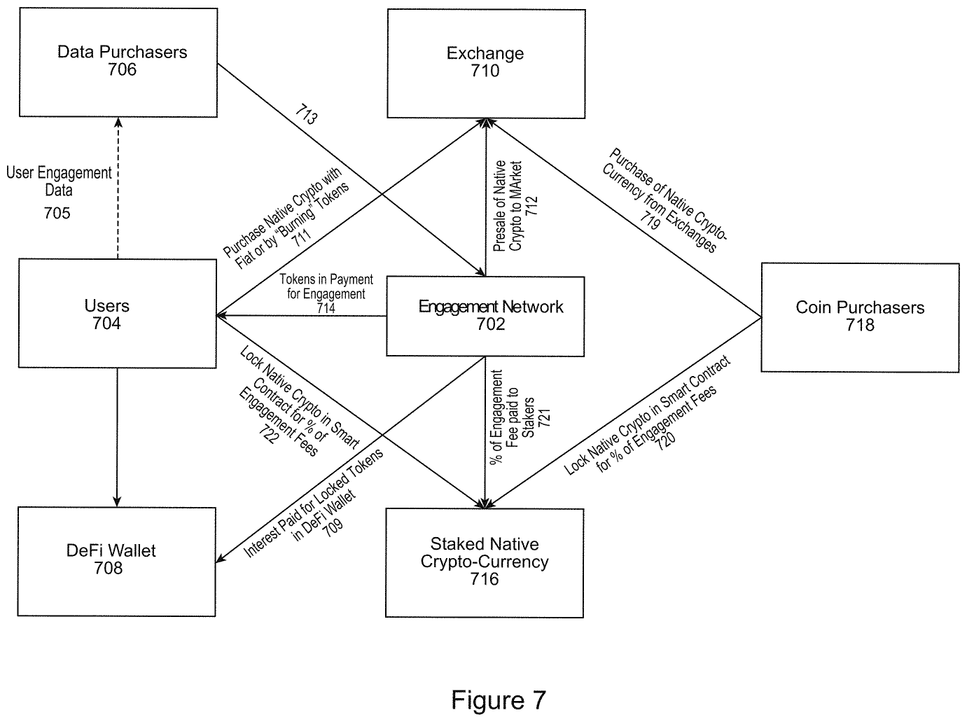

FIG. 7 is a diagram illustrating elements, components, or processes that may be implemented as part of an engagement network eco-system, in accordance with an embodiment of the systems and methods disclosed herein. As shown in the figure, engagement network 702 may be connected to or otherwise enabled to exchange data and information with users of the engagement network 704 and with entities providing services and sources of data. As examples, engagement network 702 and the other entities illustrated may interact in the following ways with users 704 and each other:
As suggested by the figure, Users 704 may earn tokens for their engagement activities (and for the engagement activities of others they cause to happen indirectly), as suggested by process 714;
Users 704 may stake engagement network's 702 native crypto-currency to support the valuation of the crypto-currency by accessing a store indicated as Staked Native Crypto-Currency 716 in the figure;
   Parties that stake native crypto-currency may be entitled to earn a percentage of fees earned by engagement network 702, as suggested by process 721;
Data Purchasers 706—this may include data analytics platforms and entities interested in data mining and analysis of data generated by users of engagement network 704;
   User engagement data 705 may be transferred directly from users to data purchasers 706 or indirectly through engagement network 702 (after anonymization, if needed);
      User engagement data 705 may be used to segment users according to demographics, engagement activities, impact of a user's engagements on others in network, or other measures of interest to advertisers, promoters, suppliers, as examples;
   Data purchasers 706 may make payments to engagement network 702 for access and use of user generated engagement data (as suggested by process 713);
DeFi Wallet 708—this represents a datastore accessible by one or more users 704 of engagement network 702 that is used to store a record of their earned tokens and native crypto-currency;
   Engagement network 702 may incorporate incentives to encourage users 704 to hold earned tokens in their respective wallet 708 to earn interest (as suggested by process 709);
   Users 704 may use tokens and/or the native crypto-currency to make purchases of products or services within the overall set of entities and service providers that interact with network 702;
Exchange(s) 710—this represents a platform or service for exchanging a crypto-currency into a second crypto-currency or into a fiat currency;
   As suggested by the figure, Users 704 may purchase the engagement network's native crypto-currency using an exchange 710 using a fiat currency and/or earned tokens (as suggested by process 711);
   Engagement network 702 may utilize an exchange 710 to execute a pre-sale of the network's native crypto-currency (as suggested by process 712);
Coin Purchasers 718 represent individuals or entities that purchase native crypto-currency from an exchange 710, as suggested by process 719 in the figure;
   Coin purchasers 718 may choose to “lock” native crypto-currency into a “smart” contract in return for a percentage of fees earned by engagement network 702, as suggested by process 720;
      As an example, participants pledge their coins to the cryptocurrency protocol, TEMPUS. From those participants, the protocol chooses validators to confirm blocks of transactions. The more coins pledged, the more likely you are to be chosen as a validator;
      Every time a block is added to the blockchain, new cryptocurrency coins are minted and distributed as staking rewards to that block's validator. In most cases, the rewards are the same that participants are staking. However, some blockchains use a different type of cryptocurrency for rewards;
      The coins are still in the possession of the user when they stake them. Essentially staked coins are put to work, and users are free to un-stake them later if they want to trade them. The un-staking process may not be immediate; with some cryptocurrencies, you are required to stake coins for a minimum amount of time;
      Staking is not an option with all types of cryptocurrencies. It is only available with cryptocurrencies that use the proof-of-stake model;
      Many cryptos use the proof-of-work model to add blocks to their blockchains. A problem with proof of work is that it requires considerable computing power. This has led to significant energy usage from cryptocurrencies that use proof of work. Proof of stake, on the other hand, does not require nearly as much energy. This also makes it a more scalable option that can handle greater numbers of transactions;
   Similarly, users 704 may choose to “lock” native crypto-currency into a “smart” contract in return for a percentage of fees earned by engagement network 702, as suggested by process 722.

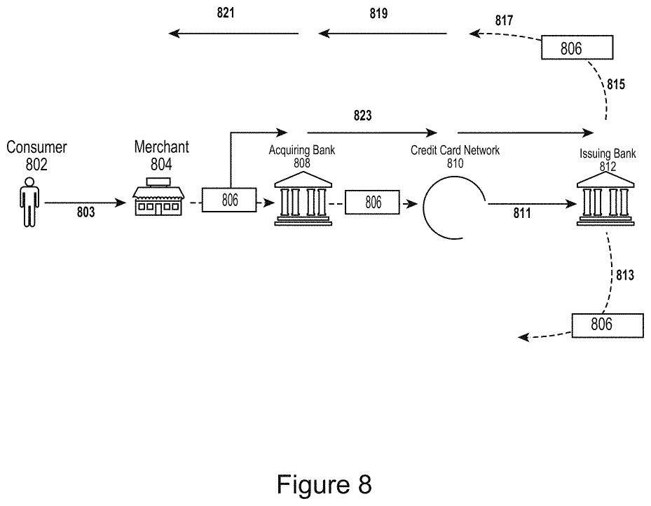

FIG. 8 is a diagram illustrating a processing flow for a payment transaction using the engagement network disclosed herein. As shown in the figure, in one example, a consumer 802 makes a payment to a merchant 804 using a bank issued debit or credit card (as suggested by process 803 in the figure). Engagement network 806 provides transactional information from merchant 804 to an acquiring bank 808. The acquiring bank's third-party provider (in this case engagement network 806) forwards the transactional information to a credit card network 810. Credit card network 810 requests a payment authorization from an issuing bank 812, as suggested by process 811.

Issuing bank 812 verifies the transaction, providing an authorization to complete the transaction using the engagement network 806, as suggested by process 813. Issuing bank 812 releases the funds, as suggested by process 815, with a discount based on the interchange rate. The funds (i.e., data representing a transfer of funds) are transferred through credit card network 810, which may apply a discount based on a scheme rate. The discounted funds are transferred through engagement network 806 to acquiring bank 808, as suggested by process 817. Acquiring bank 808 and/or engagement network 806 may apply their own respective discounts as suggested by process 819, with the resulting funds being transferred to the account of the merchant 804, as suggested by process 821. Engagement network 806 may batch verified/authorized payments for clearance and settlement processing, with that information and data transferred to the appropriate entities through a transaction information channel of the network, as suggested by processing flow 823.

Another benefit provided by the payment architecture described is that point-of-sale devices may be certified using the integrated architecture. For example, the architecture and payment processing flow provide the ability to certify EMV devices on payment rails with Banks, Processors and Acquirers for card networks. Further, the architecture allows for on boarding of alternative payment types for local debit and credit cards.

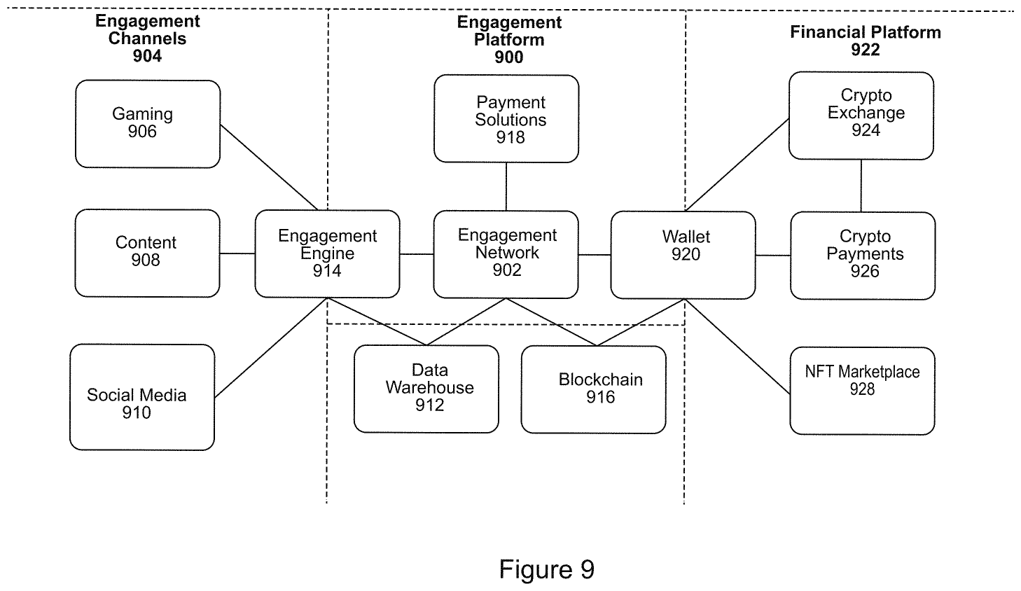

FIG. 9 is a diagram illustrating examples of one or more external systems, devices, or processes that may be integrated with an embodiment of the engagement network disclosed herein. As shown in the figure, the engagement network 902 and associated engagement platform 900 may be interconnected with one or more channels 904 that provide services, content, or activities for users. Non-limiting examples of channels include gaming 906, content 908, and social media 910. Engagement network 902 may connect with a data warehouse 912 (such as Azure from Microsoft) and an engagement engine 914 (such as PICNIC or one provided by PUG Interactive) to enables users to be directed to an appropriate or desired activity.

Engagement network 902 may also be configured to interact with a blockchain-based crypto-currency protocol (such as Algorand) to enable data storage on a blockchain and processing of blockchain based data for transactions. Network and platform 902 may further connect to and interact with a provider of payment solutions and technology 918 (such as Smart Card Marketing Systems Inc) to assist users to make payments, transfer funds, etc. Network 902 may further enable users to establish and manage a wallet for digital assets 920, by interconnecting with a provider of digital asset management solutions (such as Original Digital Corporation). A user's digital asset wallet may connect to and interact with a financial platform 922.

Financial platform 922 may include or provide access to one or more services. As examples, these may include services to enable a user to make payments using the native crypto-currency (as suggested by service 926), exchange the native crypto-currency for another form of crypto-currency or a fiat currency (as suggested by service 924), and participate in the purchase of non-fungible tokens (as suggested by NFT Marketplace service 928).

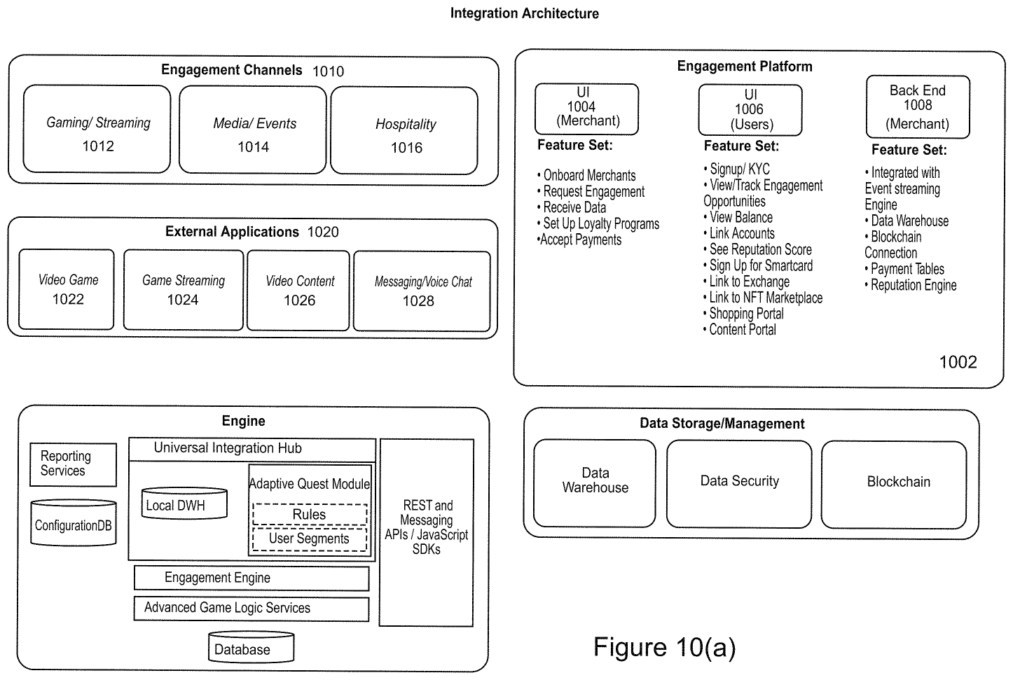

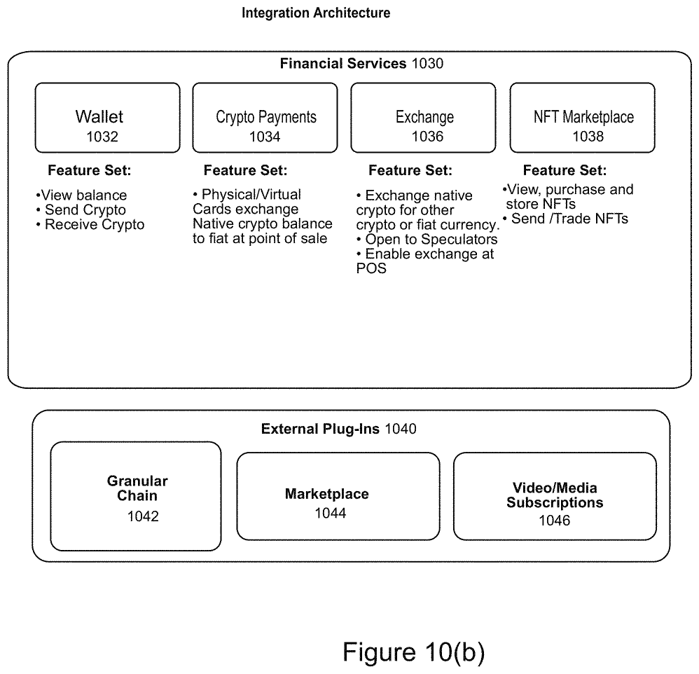

FIGS. 10(a) and 10(b) are diagrams illustrating an example of the integration of one or more external systems, devices, or processes with an embodiment of the engagement network disclosed herein. As shown in the figures, an engagement network may comprise an engagement platform 1002 that allows access to one or more services.

In one example (FIG. 10(a)), engagement platform 1002 may include a user interface accessible by a merchant 1004, and that allows access to a set of features or functions. These features or functions may include:
onboarding a merchant;
allowing a merchant to submit a request for user engagement;
receiving user generated data;
setting up a rewards or loyalty program for users; or accepting payments to the network from a merchant.

In one example (FIG. 10(a)), engagement platform 1002 may include a user interface accessible by a user 1006, and that allows access to a set of features or functions. These features or functions may include:
user registration and providing of required information based on level of access/functionality desired (such as the level 1, 2, or 3 access described);
view/track engagement opportunities;
view token/coins balances;
link accounts;
see reputation score;
sign up for a smartcard;
link to crypto exchange(s);
link to NFT marketplace;
access shopping portal; or
access content portal.

In one example (FIG. 10(a)), engagement platform 1002 may include a user interface accessible by a merchant to perform backend processing functions 1008, and that allows access to a set of features or functions. These features or functions may include:
integrated with a platform for streaming events;
access to a data warehouse;
access to a blockchain connection;
payment tables; or
a reputation value generating engine.

Engagement platform 1002 may be integrated and able to connect and exchange data with one or more engagement channels 1010, where such channels or engagement opportunities for users may include but are not limited to gaming/streaming 1012, media and events 1014, and hospitality services (e.g., loyalty programs) 1016.

Engagement platform 1002 may be integrated and able to connect and exchange data with one or more external applications 1020, where such applications may include but are not limited to video games 1022, game streaming services 1024, video content 12026, or messaging/chat functions 1028.

In one example (FIG. 10(b)), engagement platform 1002 may provide access to a set of financial services or service providers 1030, where such services, service providers, or functionality may include but are not limited to:
Wallet functionality 1032—this may include functionality to enable a user to view a balance, send crypto-currency, or receive crypto-currency;
Crypto-currency payment functionality 1034—this may include functionality to enable a user to exchange physical/virtual cards, or convert a native crypto-currency balance to a fiat currency at a point of sale;
Exchange functionality 1036—this may include functionality to enable a user to exchange/convert native crypto-currency for other crypto or fiat currency, provide access to speculators, or enable exchanges at a point of sale;
NFT Marketplace functionality 1038—this may include functionality to enable a user to view, purchase and store NFTs, or send/trade NFTs with other users.

In some embodiments, financial services or service providers 1030 may provide or facilitate interactions with one or more external plug-ins or applications 1040. These external plug-ins or applications 1040 may include but are not limited to:
A granular blockchain 1042;
A marketplace platform 1044; or
Video/media subscriptions 1046.

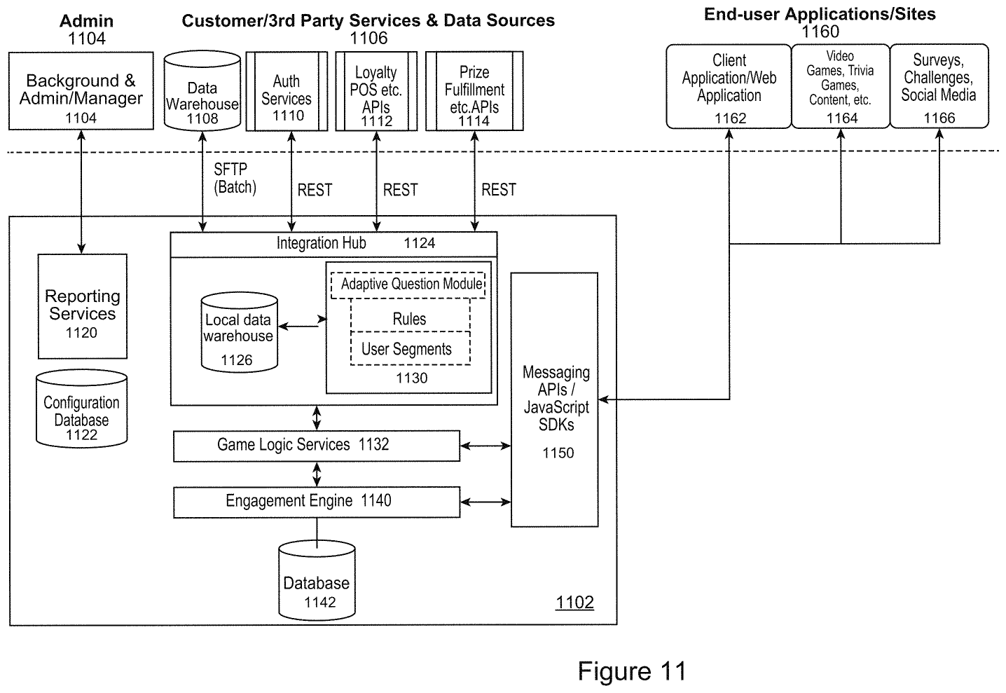

FIG. 11 is a diagram illustrating an example architecture for integrating an engagement engine with other elements, components, or processes in an embodiment of the engagement network disclosed herein. As shown in the figure, an engagement platform 1102 may be integrated or otherwise interconnected with an administrative management function 1104. Further, engagement platform 1102 may be integrated or otherwise interconnected with one or more customer or 3^{rd} party services, data sources, or other functionality 1106. These may include a data warehouse 1108, authentication services 1110, loyalty or point of sale APIs 1112, or prize or reward fulfillment APIs 1114.

As suggested by the figure, data warehouse 1108 may interconnect with platform 1102 using Secure File Transfer Protocol (SFTP) for batch processing, or by use of another suitable protocol. Services or APIs 1110, 1112, or 1114 may interconnect with platform 1102 using a Representational State Transfer (REST) architecture and functionality.

Administrative management function 1104 may interconnect with or otherwise access a reporting services module 1120 in platform 1102, where the reporting module may access a configuration database 1122 when generating reports or evaluating platform performance.

Data warehouse 1108 and services or APIs 1110, 1112, or 1114 may interconnect with platform 1102 using an integration hub 1124. Integration hub 1124 may provide access to a local (platform) data warehouse 1126, and a set of services or processes for generating questions or engagement invitations for users 1130. Services or processes for generating questions or engagement invitations for users 1130 may include (as non-liming examples) elements, components, or processes to provide adaptive generation of questions/invitations, rules or models used to control the generation of questions/invitations, and user segments representing categories or classifications of users that may provide an input to the rules or models being executed. In some embodiments, the rules or models may be used to determine the types of engagements or activities that are expected to be of greater interest to a user based on the user's demographics, engagement data, behavior, interests, or other characteristics.

Data warehouse 1126, and a set of services or processes for generating questions or engagement invitations for users 1130 may integrate or interconnect with game logic services 1132 for processing of data generated by a user's engagement with games or contests external to platform 1102. Platform 1102 may include engagement engine 1140 and connected database 1142.

In one embodiment, Engagement engine 1140 may comprise or access the following elements, components, data, operation, functions, or processes:
Basic Roll up/Counters—users are segregated based on parameters such as country or device, for example;
Retention Analytics—defines the events related to the retention of users. The data should be able to be investigated over various time ranges;
User Flows—This functionality helps in identifying the path followed by a majority of users. It will help in fine-tuning a game as per the objective of retention and monetization;
Funnels—The funnel helps in finding how many people started a game, how many people dropped out in between, and how many completed it;
Overlays—maps custom events and standard events. Primarily focused on how many users start a game and then claimed reward points. One event is standard and the other is defined by a developer;
Custom Dashboards—a dashboard provides a graphical and numerical representation of the situation defined in overlays;
Acquisition channels—the functionality to segregate users and analyze behavior based on their acquisition channel. The acquisition analytics may be the result of ingested data from paid advertising networks, application stores, cross-promotion, or virality, as examples;
Ad Responsiveness—analyzes user behavior with regards to responsiveness to different types or genres of ads and matches users and ads so that relevant ads can be shown in the future;
Messaging Engagement—analyzes user engagement in relation to in-game messages as well as notifications pushed to the users, and targeted messaging; and
External Data Sources—the platform/system ingests data from external data sources such as ad networks, app store, acquisition, and ad monetization sources, as examples.

The data generated by the disclosed platform generates value for both B2B and B2C marketers. In addition, the data is a valuable source of analytics and insights for business decision making. Businesses analyze the data qualitatively and quantitatively as per the business needs. Data warehousing and data mining technologies have given managers a number of tools that can help them store, retrieve and analyze the information contained in large databases. In business intelligence, the data warehouse is typically used to connect and analyze business data from heterogeneous sources. The data warehouse is a core element of the business intelligence system which is built for data analysis and reporting.

Services, processes, and functions performed by and/or accessible from platform 1102 may connect with external end-user applications or websites 1160 using messaging APIs, JavaScript SDKs, or another suitable method, technique, or protocol 1150. As examples, external end-user applications or websites 1160 may include a client application or web-based access element 1162, video games, other forms of games, or content 1164, or surveys, challenges, or social media content 1166.

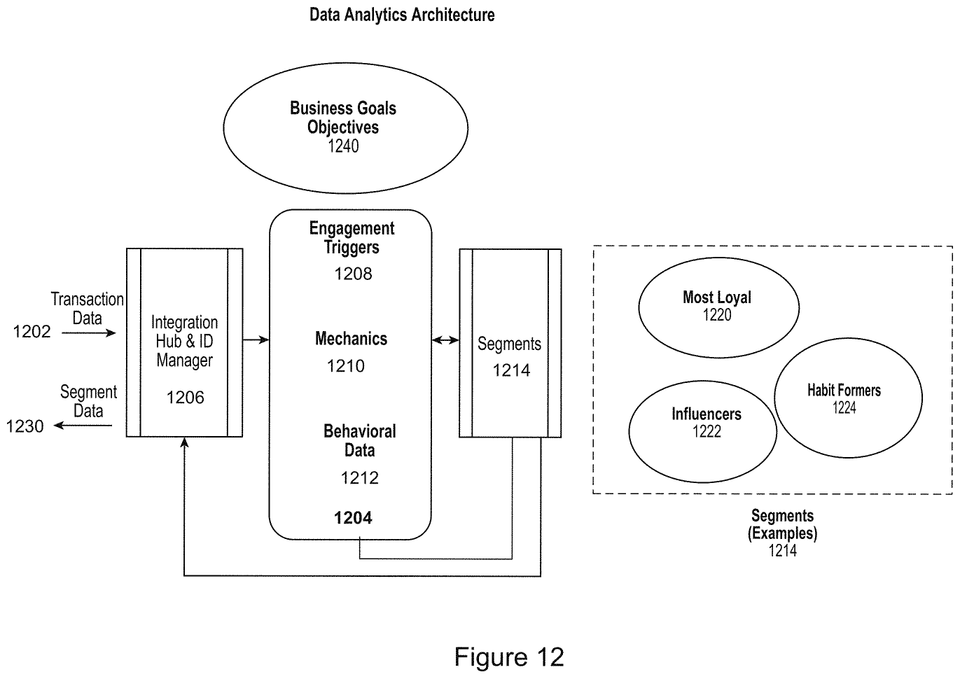

FIG. 12 is a diagram illustrating an architecture for segmenting users of an engagement network based on collected data regarding user engagements and activities, in accordance with an embodiment of the systems and methods disclosed herein. As shown in the figure, one technique for generating content that may result in users of an engagement platform engaging with a specific event, activity, website, or similar behavior is by collecting data regarding user behaviors and interactions with the platform and analyzing or evaluating that data. The results of that analysis or evaluation may then be used to “segment” users into categories and classifications, and thereby assist a business entity (such as an organization wishing to encourage user engagement) by enabling one or more of the following:
Identify users or groups of users who might be interested in engaging with the entity to assist the entity to achieve its business objectives and goals;
Formulate or assist in formulating questions, invitations, games, or surveys to provide to users to encourage engagement; or
Provide the entity with information regarding segments of users or individual users that may be of interest to the entity as part of its efforts to improve customer satisfaction, increase sales, increase profitability, etc.

As non-limiting examples, sources of user data may include transaction data 1202, which may be obtained from point-of-sale activities, employee databases, sales databases, financial databases, etc. Transaction data 1202 may be provided to platform processes and data 1204 using Integration Hub and User Identification Manager 1206. Platform processes and data 1204 may include processes to perform one or more of:
Identifying what are termed engagement triggers 1208 in the figure—i.e., techniques used to cause a user or users to become engaged. As examples, these may include user choices of activities, calls to action that caused a user to become engaged, user responses and opinions, identifiable trends and patterns in user interactions with the engagement platform, and repeated user actions;
Techniques for determining causes or factors that may have led to user engagement 1210—termed “mechanics” in the figure, these may include adaptive questioning, identifying economic-based decisions, identifying decisions resulting from one or more of competition, vanity, collaboration, or prestige, identifying qualitative/curatorial expressions, rewards, or sources of recognition; and
Behavioral data relevant to a user 1212—this may include information and data collected from users or identified through evaluation of behaviors of users.

The described processes and data 1204 may be used to separate or classify a set of users into one or more categories, termed segments 1214 in the figure. Each segment may correspond to a set of users having one or more common characteristics or behaviors. Non-limiting examples of segments may include those noted as the following in the figure:
Most Loyal 1220—these may be users who completed multiple engagement activities, demonstrated repeated participation, responded to calls to action, etc.;
Influencers 1222—these may be users who are active on social networks, those who build a reputation, those who curate friends, etc.; or
Habit Formers 1224—these are users who completed multiple engagement activities, whose activity increases over time, etc.
   In general, segments are dynamically updated and exposed via Integration Hub 1206 to external systems (as suggested by segment data 1230 in the figure). As mentioned, segments may be used to determine who receives specific engagement activity information or requests.

As suggested, segmenting users may benefit an entity by identifying people more likely to engage in behaviors that will assist the entity to achieve a business goal or objective 1240. Such goals or objectives 1240 may include but are not limited to engagement to drive compliance, generating calls-to-action, increasing purchases or profits, increasing referrals, improving customer satisfaction, etc. The data collected from users may assist the entity to achieve its goals and objectives by providing insights and responses to questions through data analytics, machine learning modeling, rule-sets, and other forms of data mining or evaluation. As non-limiting examples, the data analytics, machine learning modeling, rule-sets, and other forms of data mining or evaluation may assist an entity to identify its most loyal customers, determine which customers have built beneficial habits, determine which customers make referrals, determine which customers are likely to spend more, or determine which customers respond to qualitative values.

In one embodiment, pre-defined segments that target specific business goals and questions may be used as a baseline or to define a desired segmentation category. Such segments may include loyal customer, referrer, promoter, expert, or sharer, with each category encouraged to engage using a different technique or approach. As suggested by the figure, user segmentation data 1214 may be used as an input to platform processes and data 1204 as part of generating engagement invitations and provided to external sources using hub 1206 for purposes of analytics or other forms of evaluation 1230.

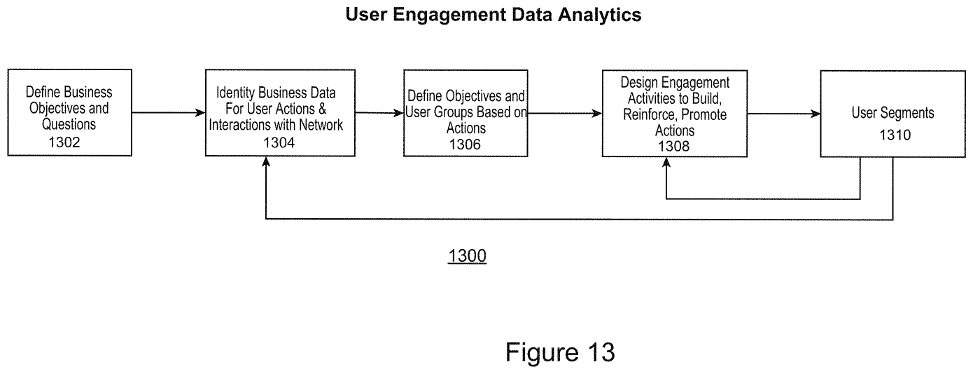

FIG. 13 is a diagram illustrating elements, components, or processes that may be implemented as part of a user engagement data analytics model, in accordance with an embodiment of the systems and methods disclosed herein. In one embodiment, FIG. 13 is an example of a processing flow 1300 for performing the user segmentation process described with reference to FIG. 12. As shown in the figure, an entity may first define its business objectives and/or questions it seeks to answer about users, as suggested by process 1302. Next, the process may identify business data that reflects user actions and interactions with the entity through the engagement network, as suggested by process 1304. The entity or process may then define or refine the business objectives and associate them with user groups and/or user actions that will support achieving those objectives, as suggested by process 1306. Based on that association, the process may design or define engagement activities to build, reinforce, and promote the desired actions, as suggested by process 1308. An output of the processing flow may be one or more user categories or segments (as suggested by process 1310) that are generated and may be used to modify the design of the engagement activities 1308 and/or serve as inputs or controls for an analytics process performed or executed at 1304.

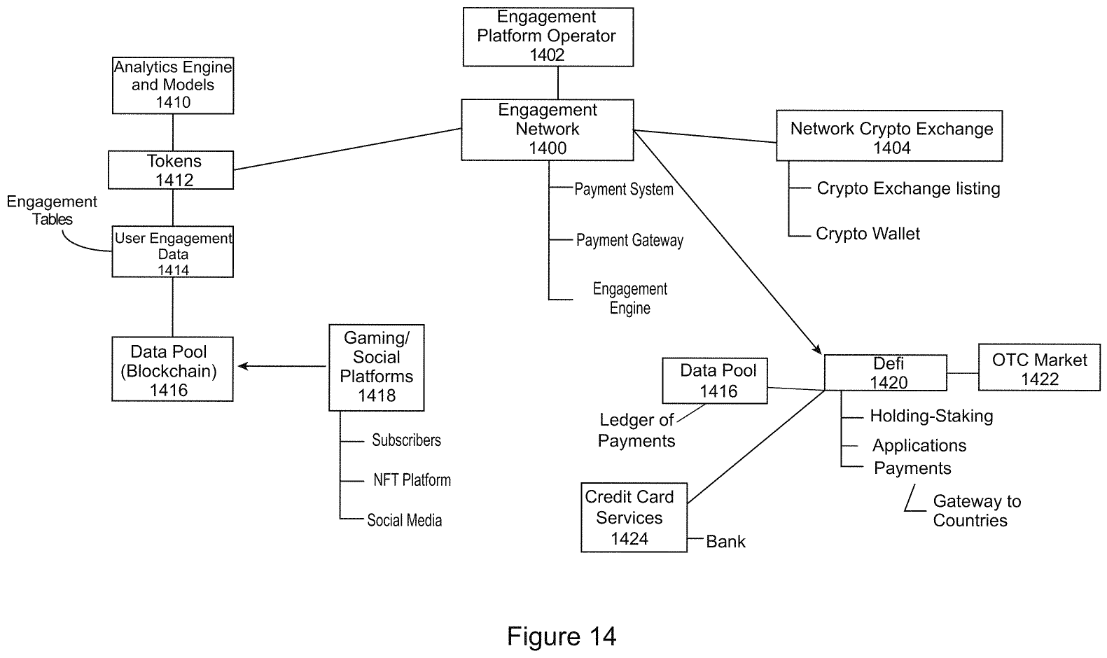

FIG. 14 is a diagram illustrating an example architecture and relationships between elements, components, or processes implemented as part of an engagement network 1400 and external elements, components, or processes that form part of an engagement network eco-system, in accordance with an embodiment of the systems and methods disclosed herein. As shown in the figure, network 1400 may interconnect with a platform operator 1402. Network 1400 may comprise services or functionality including a payment system, a payment gateway, and an engagement engine, for example.

Network 1400 may include backend database(s) and processes to store user data, perform and store analytics and records of user interactions, and provide internal connectivity to a decentralized banking system to enable financial transactions and settlements that function to convert a user's time and actions into tokens, and then into a native or other crypto-currency or fiat currency.

Network 1400 may comprise a network crypto exchange 1404, which may facilitate a listing and a crypto wallet to enable users of network 1400 to store tokens and native crypto-currency, and to convert or transfer native crypto-currency to other crypto or fiat currencies.

Network 1400 may further comprise or be integrated with elements, components, processes, or functionality to perform analytics or modeling on user data 1410, generate and manage earned tokens 1412, collect and store data related to user engagement activities 1414 (which as suggested by the figure may include engagement tables or records), and store user data on a blockchain 1416. Blockchain stored data 1416 may also be provided or created by gaming or social platforms 1418, which may generate data or provide access to subscribers, an NFT platform, and social media sites or networks.

The blockchain stored data 1416 may include a ledger³ of payments of tokens to users, payment by users to merchants, exchanges of earned tokens to native or other crypto-currency and may be accessed by a set of DeFi (decentralized finance) services 1420. Decentralized finance services 1420 may include one or more of enabling holding or staking of native crypto-currency, applications for use in trading or converting crypto-currencies, payment and financial services (such as suggested by FIG. 10(b)), including services connecting network 1400 and its users to other countries. ³ The engagement network ledger may be implemented to include a parameter intersection model that will continue to learn based on text, including conversations, questions, answers to questions, and documents by understanding features that are related to outcomes (such as enhancing customer or client experience, promoting community thought) using language modeling and understanding techniques.

Decentralized finance services 1420 may also include connectivity with an over-the-counter market 1422 for use in acquiring and trading crypto-currencies, and credit card, debit card, and similar banking services 1424.

As disclosed herein, the engagement network is a platform and set of associated services (including services for the conversion/exchange of earned tokens) that enable a person, regardless of geography, age, gender, economic status, or educational level, to use the Internet as a tool to earn income through digital assets to feed, clothe, and house themselves.

Once it is developed, the engagement network will be a global platform where people will be able to account for the time they spend on an activity, event, or taking an action and have that convertible into a value in their local currency. A person's engagement time and activities will create value that is represented by the Tempus token and is placed behind (i.e., in support of the valuation of) an asset-based digital crypto-currency (the Tempus coin). A record of the earned tokens is maintained on a balance sheet, which provides proof of ownership and a means to value the Tempus platform. Examples of such activities, events, and actions include but are not limited to social media and gaming platforms, and “gamification” of Education, Charity, or Sports activities.

The value “earned” by a person is typically (although not exclusively) a function of several factors. These may include the amount of time spent on an activity, the event, or taking the action, engagement with a particular activity, event, or action, the impact of that time spent, and the reputation of the person.

The value of the time spent is converted to “sweat equity” by the relationship between the determined number of earned tokens and the valuation of the crypto asset. The Tempus network and token (referred to as Kairos herein) form an income source that allow the time and actions of a person to be captured and compensated using a digital token and associated native crypto currency that can be converted into fiat currency.

Time that is not monetizable is worth a significant amount and is lost to people that are currently using the Internet as a medium to engage with others and with activities, information, etc. Typically, a conversion between time spent and value to create income only occurs when the time is spent in a manner desired by someone paying for the labor. In contrast, the engagement network introduces a form of economy based on the value created by a person's expenditure of their time and the value of the data they create that has value to another entity.

In some embodiments, actions by a person on social media and other platforms that are monetized by third parties is instead captured and converted to a digital asset token earned by the person. That token value supports the value of the native crypto-currency (the TEMPUS coin), which a person can convert to local currency for use in their economy. The engagement network provides a mechanism for those that wish to live without competing in an open market economy to have the ability to earn enough to receive healthcare, feed, house, and educate themselves without debt and with less concern about real wages keeping up with inflation.

A user's data on the blockchain as well as the engagement network's measurement of its effect on other users' engagement may be used to establish a reputational score for the user and thus an internal measure of the real value of their time and the effective value of their engagement and activities. For example, someone interacting with an object on a social media platform or speaking and/or messaging about a product may receive a set amount of payment for that first interaction and a “royalty” based on the effect of their messaging as indicated by its impact on others.

In one embodiment, data based on a user's time of engagement as well as the longer-term value of that engagement (due to its impact on the engagement and actions of others) may be made stored in a separate database and made available to data purchasers. The data purchasers may “mine” the data or use it to train machine learning models for purposes of advertising, promotions, studies, or other forms of analysis. The Tempus network allows the true value generated by a user's engagement to be captured and converted into a form in which the user is compensated for the value they create, instead of the value of the data going to the social network that captured the data.

As described, in one embodiment, the processes implemented by the Tempus network may include one or more of the following stages, steps, operations, functions, etc.:
User creates data by engaging with the Tempus platform hosting the engagement network;
   A user's engagement may include both viewing a webpage or launching an application, as well as activities such as linking to a webpage, registering with a brand, playing a game, interacting with others, posting a review, etc.;
The engagement network determines the value of the data created and places it on an internal blockchain; The engagement network sells the data to one or more data purchasers (this is optional and may include entities performing data mining, training of machine learning models, advertisers, etc.);
Value of the user's data is placed behind the token (an internal account on a blockchain);
   By this is meant that data is a new form of currency on which today's wealth depends. Data has become an engine that powers companies across numerous sectors. They rely on consumer data to drive profitability by influencing the decisions taken by the end consumer. The data gathered by companies does not consist solely of conventional identity details, and the valuation of such companies is directly linked to the underlying value of user data;
   Another way to visualize the value of user data is to generate an estimated value of each user's data from an acquisition, given a purchase price and the number of active users;
   The value of user data may vary but depends at least in part on the earning potential expected from each user. The value of user information also depends on the industry a company operates within and hence the type of data it gathers. The wider and richer the information a company can obtain, the more the revenue it can realize by leveraging users' data. Therefore, the worth of a consumer's data and the valuation of a company are intertwined. As described herein, certain user actions can be stored on a ledger and valued as much as click through links are conventionally, with the additional value of the users' time spent tied to a minimum cost of living in the user's geographic area;
User transfers earned tokens to wallet for safekeeping;
When the user wants to use the token in the engagement network to make a purchase or conduct a transaction, the user conducts the transaction through the network; and
If the user wants to convert earned tokens into a fiat currency or crypto-currency, the user instructs the engagement network to convert the tokens using the intermediary of the native crypto-currency (which is listed on a decentralized exchange).

In some embodiments, users' engagement and activity data as measured over time is verified and placed on an auditable block-chain and enabled to be converted to monetary value using stacked self-attention and point-wise, fully connected neural network layers for both an encoder (data creator) and decoder (the engagement network).

In one embodiment, the disclosed neural network provides a mechanism to generate a total value of a person's work, their created data, and its value across the community in which that work is performed and across all platforms in which a user engaged.

In one embodiment, the collected data may be used to describe the general properties of the data and built up over time to be better able to estimate or predict the total value created. The data and neural network or other trained models may be used to forecast user value based on patterns gathered from known data. For example, user value may be a function of the total amount of value created and the value of the user's community based on specific interactions by an Avatar. The collected data may be used as part of a learning algorithm for a neural network that is “trained” using unsupervised learning. This form of learning may be used to capture characteristics of an underlying probability distribution and make intelligent decisions based on the properties of the distribution. In one embodiment, a task of the learning algorithm or neural network is to “predict” the value of a valid input from an Avatar based on its action over time. In the case of a data creator, the neural network can help predict when a player may play, how long the player may play, and the average output value they would be expected to create over time.

In one embodiment, the data flow within the eco-system comprising the disclosed engagement network may include one or more of the following elements, components, processes, operations, or functions, with the associated characteristics:
Engagement network: may be implemented as a closed loop system of data measurement, access, and storage on a blockchain with an accompanying logic that determines a monetary value (in one or more of tokens, native crypto currency, other crypto currency, or fiat currency) for a user's time spent on engagement and activities, both in direct and indirect terms;
   In some embodiments, the network measures the indirect (second or higher order) impact and value of the data created by measuring a user's effect on one or more social media or messaging platforms as determined by counting user interactions (e.g., shares, responses, and total amount of activity). This effect or impact is also measured and compensated in monetary terms as reflected in data in a payment ledger stored in the Tempus network system;
AI Engine—may include stored data tables that are comprised of:
   User Identity tables or records; and
   Records of User interaction with the platform data;
      While many learning algorithms used at present are supervised, in some embodiments, the disclosed platform uses unsupervised learning. In this form, the system evaluates data on its own to identify “hooks” embedded in the games that identify user behaviors. Using this approach, the platform can use Machine Learning (ML) to identify nuances of consumer behavior and profile the psychological aspects of a buyer;
      In one embodiment, the AI Engine may comprise one or more of the following elements, processes, components, functions, or capabilities:
         An Insight Engine that captures and codifies the real-time insight and context of individual users, including touchpoint, time, and identity;
         A Customer Profile that combines real-time insight and intent together with historical behavior (past activity, actions, device, location, responses) and uses Machine Learning to inform the decisioning and orchestration engine;
         An Intent Analyzer that operates to uncover a deeper level of actionable journey intelligence and insight. In one embodiment, it surfaces patterns of customer behavior which reveal intent and significant activities. May be used to build enriched customer profiles, intent-based audiences, and predictive models, and then determine enhanced decisions;
         A Real-Time Decisioning & Orchestration Engine that operates to deliver personalized and optimized interactions across touchpoints (on and offline) based on context, journey behavior, and profile attributes. This engine may determine a desirable action based on all customer insights, using one or more of applicability, eligibility, blocking, saturation, and prioritization rules to ensure the next-best-interaction. The engine may contain a personalization engine and an AI-driven learning model that predicts and delivers actions across channels to drive engagement;
Parameters of user engagement as measured on and off the platform, and in some embodiments as defined by tags the user embeds into the interaction(s); and
Measurement of the total actions by the user in a “Metaverse” or through IoT measured devices in the “real world” and the corresponding monetary compensation for that effort.

In one embodiment, a goal of the disclosed engagement network user data storage and processing architecture and implementation is to reduce sequential computation of actions and apply filters based on learned algorithms to identify data that is valuable and contributed to a result or resulted in influencing others. This can be useful in both assigning a monetary value to user engagement and activities and in assigning a value to the data for purposes of its use by external platforms.

The collected data also provides training data and/or input data for a neural network within the network. The neural network represents a trained machine learning model, and computes hidden representations in parallel for input and output positions of data. In such a model, the number of operations required to relate signals from two arbitrary input (users) or output positions (algorithm results or data processing tied to the network ledger) increases with the distance between positions, linearly for the network and logarithmically for the native crypto-currency coin which is its monetary value output.

For example, perception scientists seek to understand how living organisms recognize objects. To them, deep neural networks offer benchmark accuracies for recognition of learned stimuli. Today, machine learning is used as a statistical tool to decode brain activity. In the future, deep neural networks may become recognized as a model of brain function. To study perception, physiologists measure neural activity and psychophysicists measure overt responses, such as pressing a button.

This situation makes it computationally efficient to learn dependencies between distant data creation and value positions in a Recurrent Neural Network (RNN). As an example, in a user transformer structure of an architecture, data is reduced to a constant number of operations, albeit at the cost of reduced effective resolution due to averaging attention-weighted positions, an effect that may be counteracted with multi-head attention. Self-attention is an attention mechanism relating different positions of a single sequence to compute a representation of the sequence and has been used successfully for a variety of tasks including reading comprehension, abstractive summarization, textual entailment, and learning task-independent sentence representations. End-to-end memory networks are based on a recurrent attention mechanism instead of sequence-aligned recurrence and have been shown to perform well on simple-language question answering and language modeling tasks. However, the described user data transformer on the blockchain is a transduction model relying entirely on self-attention to compute representations of its input and output without using sequence-aligned models. The transformer motivated self-attention model with a feedback loop can assess, score, and create a representation value for an identity within the ecosystem in which it operates.

### Model Architecture

Neural sequence transduction models may utilize an encoder-decoder structure. In some embodiments, the Tempus network will employ the structure for extracting its data and placing it on the blockchain.

Self-Attention Model for User Data Retrieval Self-attention sublayers employ h attention heads. To form the sublayer output, results from each head are concatenated and a parameterized linear transformation is applied. Each attention head operates on an input sequence, x=(x₁, . . . , xₙ) of n elements where xᵢ∈R^{d}^{ₓ}, and computes a new sequence z=(z₁, . . . , zₙ) of the same length where zᵢ∈R^{d}^{_{z}}. Each output element, zᵢ, is computed as weighted sum of a linearly transformed input elements. This is a known computational model for self-computational networks.

Note that IoT devices can be used to measure user data as part of determining its value through a device that can monitor and place human or non-human work onto a blockchain as evidence for that work done and convert that to a numerical value that can be converted into a currency.

In one embodiment, transactions within the network may be considered as earned income for the users, and the network generated engagement data will be tracked so that user's activities can be the subject of any applicable income or other forms of tax for goods, services or earned income. Thus, the data collected within the Tempus platform, which will be associated to each user's digital identity and local address, may be taxable as income in their local country, state, or other form of jurisdiction of residence.

In one example of an implementation, the disclosed engagement network may incorporate gaming partners to take advantage of the active and immense gaming industry, with the hopes of transitioning into gamification of other sectors such as education, entertainment, and charity. In conventional uses, the integration of blockchain into gaming is somewhat difficult because most of the necessary infrastructure does not exist or is not optimized for gaming. While tokenizing digital assets in games so they can be uniquely identified and tracked is relatively easy, to enable a greater market opportunity, a simple hybrid wallet solution is more desirable. Further, game developers and digital asset platforms should be careful to prevent creating an environment in which money laundering may occur. This may require that all users be verified as compliant with anti-money laundering laws as well as fund transfer laws in the countries where the engagement network has users.

While brand engagement is one area of disruption made possible by the disclosed engagement network, the gamification of engagement will have a separate but equally powerful impact on gaming, education, and labor. As a blockchain-enabled engagement-backed currency, the engagement network becomes an infrastructure company as well, using blockchain technology to enable new kinds of gaming-like economies. Secure network digital wallets will store and exchange player's various tokens and assets between game-specific currencies.

As non-limiting examples of such gaming-like economies:
Play-to-earn games could bring digital identity, assets, and ownership into players' hands as the gaming industry is becoming decentralized;
Conventional video games may introduce new paradigms that lend themselves to a wide variety of emerging digital environments and forms of value creation;
These games are also spearheading a recent development: the increasing convergence of the physical and digital worlds;
An innovative aspect is the decentralized integrity and security of these digital items, which can transcend the traditional proprietary, custodial ownership and discretion of a company or even a government. As an example, instead of relying on the permission or rules of publishers or other third parties, in game resources from play-to-earn games can be sold freely on marketplaces both inside and outside of the game;
It is worth noting that play-to-earn games do not inherently and fully eliminate the centralization found in games: they still require the authority of the publisher to define, issue and constrain the asset that eventually is traded as an NFT. Rather, the promise of play-to-earn and Engage-to-Earn games is in their potential to decentralize marketplaces for the creation, ownership, and exchange of digital assets, as well as the potential created when these marketplaces are connected to the traditional economy and fiat currencies. This allows players to transfer their digital time, effort, and earnings into disposable income in the physical world.

The disclosed engagement network's “engagement as currency” model will address problems in the global distribution of revenues generated from social media interactions and gaming, which are overly dependent on a small number of companies that collect the revenue and share none with the users whose data is being commercialized. In the disclosed network model, value is created by time spent engaging and is converted into the transferable form of native coins that may be listed on credible exchanges.

In a multiplayer game, players often form groups like clans or guilds. These clans will have the ability to use blockchain rewards or other digital assets to incentivize their own players to go on a quest or complete a task for the clan. This gives players control over items they can earn together as a group. The engagement network envisions a sustainable and equitable eco-system for games and is and infrastructure that can make it possible.

The disclosed economic model enables streamers and user-generated content creators to amass fans and make a living by entertaining or selling goods to these fans. Users can make a living from the games they enjoy and generate a return on the time they invest in the games through the rise in value of their investments, such as NFT items and the TEMPUS coin. This form of economy also benefits gaming companies by enabling game creators to modify their games to create a revenue stream from monthly sales for both the gaming company and the creator while giving the game greater appeal and longevity. Further, game or platform administrators can set up paywalls for exclusive content and ask for donations, while users can send tokens peer-to-peer, buy/sell goods and set up escrow accounts to ensure a condition is met prior to a reward being released.

The engagement program is a social product, meaning it will require integration with social media and messenger platforms, driving customer acquisitions through various platforms and platform channels. This will enable users to communicate with each other and with brands and enable brands to make direct offerings to users via their own channels. Users will use one User ID for all aspects of interaction with the engagement network, including messaging as well as the sending/trading of tokens and currency.

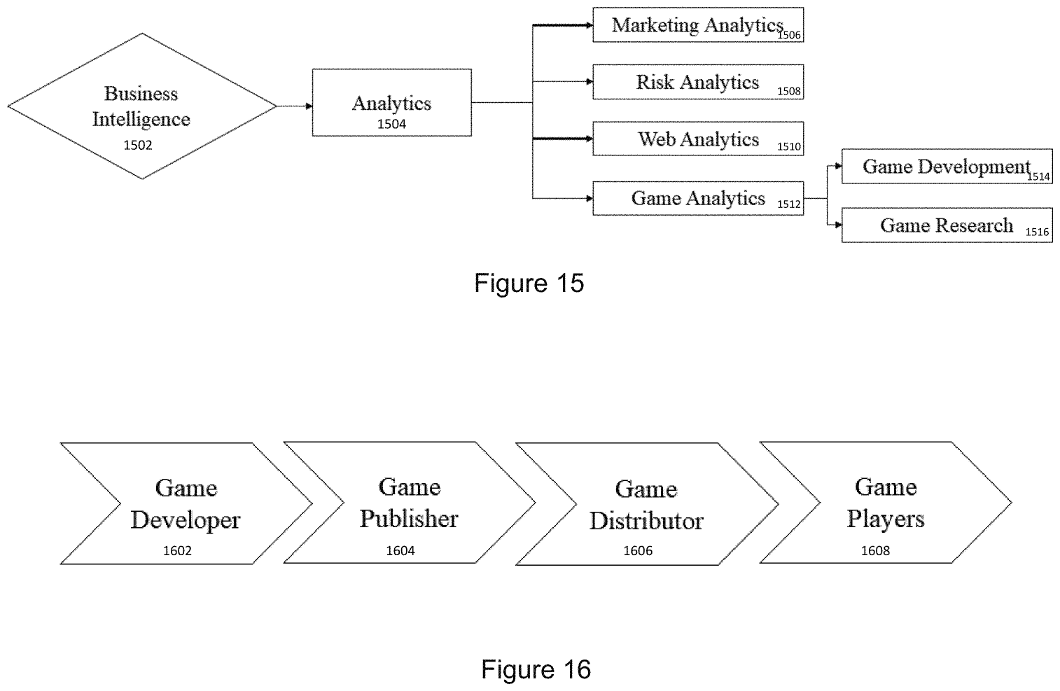

The following describes in greater detail the generation, acquisition, and use of in-game data (the tele-metrics referred to herein). FIG. 15 to FIG. 20 are diagrams illustrating aspects of the discussion of game and player data, metrics, and analytics and the significance of those to game development, game publishing, and game revenue as an example of a use case of the disclosed systems and methods.

As the creation of data and platforms that house it proliferate worldwide, the question of who owns that data and how it is monetized becomes a fundamental issue. As disclosed herein, a true measurement of value of the data users create, and one based on actions which are measured at a granular analytical level and tied to an index that creates a composite valuation of their effort may be used to create and implement a new economic model. This is because a main issue with conventional platforms is that they have not created open interconnective platform that provides a way to generate an accurate measurement of the real value of a user's data and engagement.

As a non-limiting example, the following is a detailed description of an implementation of the concepts and functionality disclosed herein in the context of a gaming or gamified platform. This represents a use case that demonstrates the type of data that may be generated, and how it may be used to generate one or more measures of the value of the data and the user's engagement.

An abundance of new sensor devices such as in-vehicle sensors or handheld mobile devices will provide sets of real-time data (e.g., on traveler locations, speeds, and routes), which could be integrated with social media data to further improve understanding of users' behaviors and conditions in real time.

However, to utilize data sets for gamified applications, one needs to understand the characteristics of the data generated by a range of social media platforms and the methods that can be used to mine, organize, store, process, interpret, and communicate these data, and to associate the data to a monetary value. This task, of enabling a conversion or translation of a user's time spent engaged with an on-line activity and the beneficial direct and indirect impact that provides to others, is a primary function of the disclosed systems and methods. In some embodiments, this value has multiple components, and when calculated, may be converted into a user's local currency. Moreover, the access to and processing of user's data is performed while ensuring the social media user privacy and data security.

In one embodiment, the disclosed tele-metric algorithm operates to extract social media data characteristics that are relevant to user attention-related applications, and address issues involving the data use and analysis. As shown in FIG. 15, there are several branches of data analytics 1504 that form part of business intelligence 1502 these include marketing analytics 1506, risk analytics 1508, Web analytics 1510, and game analytics 1512 (which has been used in some form in the game industry previously). As illustrated, game analytics 1512 may be further categorized as game development analytics 1514 and game research analytics 1516.

There are different types of telemetry and metrics systems employed within the gaming industry, reflecting varied usage scenarios across different game forms and formats, as well as the different stakeholders involved, FIG. 16 is a diagram illustrating the primary stakeholders. As shown in the figure, these include game developers 1602, game publishers 1604, game distributors 1606, and game players or end users 1608. Each of these stakeholders may be interested in or attach value to data generated by game players or other users, both as part of game development and as part of game marketing or other aspects of the gaming eco-system.

One focus of the disclosed approach is the telemetry applied with regards to game developers, herein termed “developer-facing telemetry”. A goal of the disclosed platform is to facilitate and improve the game or virtual environment production process by gathering and presenting information about how developers and testers interact with an unfinished game, so that the “touch points” of player's behavior can be built into the game and can be measured in real time.

This contrasts with user-facing telemetry, which k typically collected after a game is launched and is aimed at tracking, analyzing, and visualizing player behavior. This data is also collected by the disclosed platform and is used to create metrics to assist in monetizing user data derived from engagement activities.

In some embodiments, aspects of the disclosed platform and approach comprise:
Deployment of a telemetry system, from the data sources to eventual analysis, and integrated in an existing pipeline;
Collecting and analyzing game metrics during the game production process;
Developing strategies for monitoring a developer's use of tools for evaluating and enhancing the production pipeline, quality assurance methods, and workflow;
Inclusion of telemetry systems in popular 3D engine middleware;
Strategies for selecting a representative and valid sample of users to collect data from; and
A design philosophy and concrete implementation of an open-source API for log creation that can be aligned with Fintech and other 3^{rd} party applications.

Conventional practices and use of game analytics (and the associated data) have attracted more and more attention, but still have problems in implementation and use of data through the game industry value chain. Using data analytics to drive game publishing more effectively and to implement better game metrics to measure the value of game updates and channel performance are a part of the disclosed platform and its capabilities.

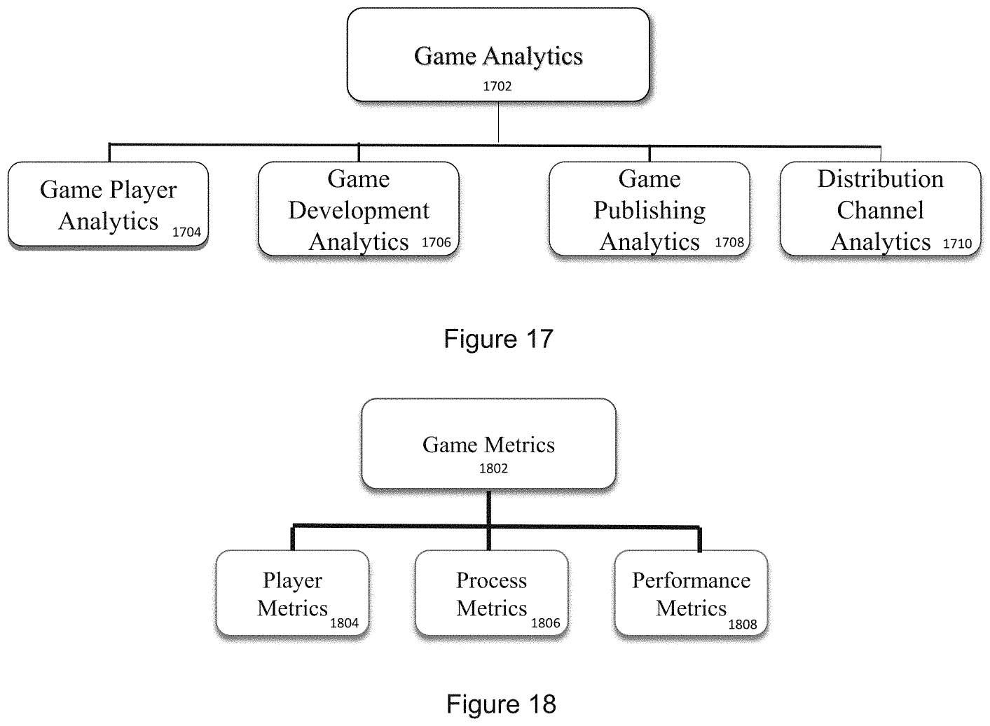

FIG. 17 is a diagram illustrating how game analytics 1702 may be described in terms of data and analytics gathered from, of interest to, or of value to game players 1704, game developers 1706, game publishers 1708, or game distributors 1710.

Game player analytics is based on the behavior analytics of game users. Player behavior in a game may change and may generate a significant amount of data, particularly in environments such as MMORPG games. Improving the efficiency of player analytics through the processing of massive amounts of data is a challenge. However, the player analytics results are established based on data collection, which creates two problems or issues of concern.

Firstly, how to obtain accurate results with little data to save the data collection cost is a potential issue. Secondly, how to ensure that the collected data can represent a player reliably and sufficiently accurately is also a challenge. A goal of player segmentation analytics is to classify the player groups further and provide games more in line with each player's requirements. It is also worth considering how to meet the needs of different players in the same game based on player analytics. To assist in achieving these goals and resolving these issues, the disclosed platform utilizes a unique user identity and a Reputational score maintained on a blockchain ledger to define and save unique player attributes.

At present, most game analytics research for game development focuses on ensuring that the gameplay is sufficient to meet the player requirements and that the game development process is controllable. However, how best to ensure that the in-game system design can be adjusted according to player behavior and feedback after the game launched is almost ignored. Ideally, the design of the in-game system needs to be dynamically changed according to the player feedback, rather than being unchanging. Hence, game analytics used for driving game development may need further development and be able to adjust in response to processing of in-game data, such as by using algorithms that adjust to the dynamic changes of users and game environments.

At present, most research focuses on the game retention and revenue analytics side. There is a lack of detailed analytics about the process of game publishing. For example, releasing new game content is essential for game publishing, but how to evaluate a new version or update is largely unknown. The performance (or success) of a new version or update can be related to measures of user engagement and behavior, such as those disclosed herein.

The lack of game publishing analytics makes it hard to form an effective game optimization after the game launch. It may also lead to game publishing failures. Besides this, with the emergence of third-party distribution channels, indie game developers who have fewer resources for the game development can submit their games to these channels and publish games themselves.

Channel analytics is ignored by most game analytics developers. However, for games, distribution channels differ from other marketing channels as game channels have their own characteristic attributes. For example, players from one store channel are quite different from those of another channel, which results in differences in performances of the same game in the different channels. The attributes of games also have an influence on the distribution channels. In addition, the channel attributes and benchmarks are factors that restrict game distribution from the game industry side.

Channel analytics is based on data collected from different channels. Accessing this data is a potential challenge—in theory, game-related metrics can be used to measure changes in users' participation in games and the data can be evaluated using game analytics, and then combined to yield channel analytics. However, there is presently a lack of corresponding metrics and analysis for the game channel side, which impacts the channel analytics challenges. To highlight the critical role of channels for game distribution and promotion, it would be desirable to place more effort on understanding channel distribution data, and the use of data analytics to target desirable players in existing channels and reduce the cost of game promotion. In this regard, the disclosed capability to identify and measure the impact of a participant in an experience, both through their direct engagement and the engagement of those they influence, provides data that may be used to evaluate channels, distribution methods, and even game features.

At present, game prediction research focuses on predicting player churn and expected game revenue. However, the prediction of game revenue is primarily focused on predicting player purchase behavior. While useful, this approach lacks a more complete analysis of game revenue based on historical revenue data generated by the expected users, as that depends on game features, distribution channels, and other factors.

In practice, game developers face issues with regards to how to generate a reliable revenue forecast for their games during the game publishing process. This is important, as based on the revenue forecast, they plan for marketing and promotion, such as how much of a marketing budget needs to be used for different channels and for new user acquisition. The prediction of game revenue, and specifically, the estimation of future revenue based on the historical game revenue data as that data is evaluated for each user, will assist in estimating revenue and profitability.

At present, most game data visualization efforts focus on providing tools to collect and represent game data, such as a visual representation of player data, displaying all data through visual information, and enabling analysts to interact with collected data. However, few platforms focus on the visual data provided by the game itself, such as the in-game data visualization. This may be an oversight, as the visualization of in-game data can help players become familiar with the game and enhance the gaming experience. Providing players with a visualized gaming experience inside the game using game analytics is a possible use of the disclosed data collection and analysis approach disclosed herein and may allow players to enhance their performance.

Game player analytics, game development analytics, game publishing analytics, game distribution analytics, game prediction, and data visualization may all be of value. Embodiments may then use these categories of data to structure the presentation of results to players, developers, and publishers.

A main purpose of using analytics in the gaming industry is to analyze the collected data to assist in game development and design. Second, based on data analysis, a game developer can effectively reduce the risks inherent in game development and publishing. Further, through game analytics, developers can add compensation, Play-to-Earn, and Engage-to-Earn models into their games more effectively.

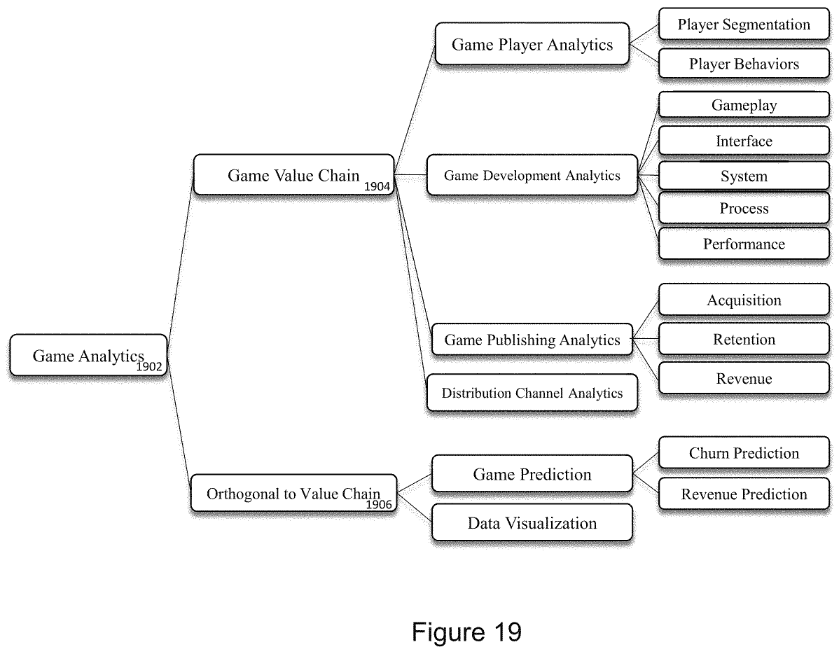

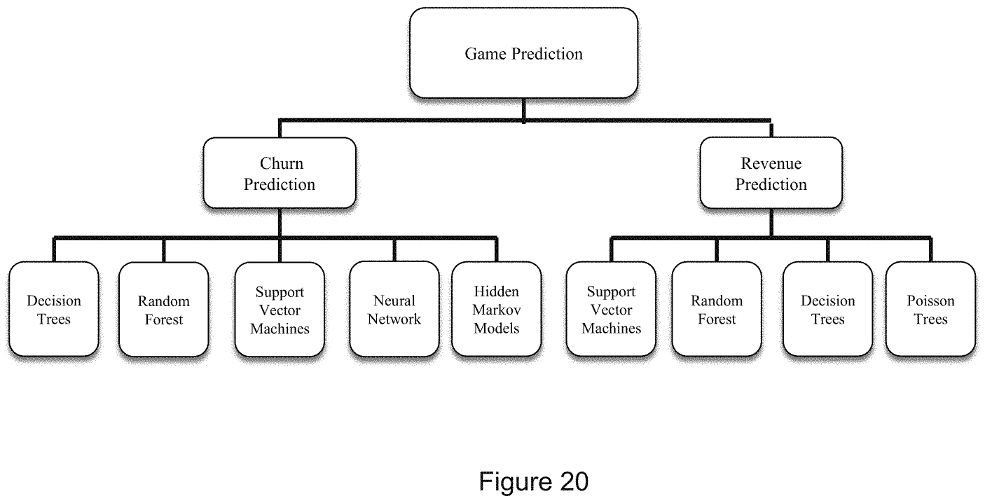

Among other benefits and uses, game analytics can help to predict trends, understand player churn rate, and predict game revenue. There are currently different algorithms that can be used for churn prediction, and these include Decision Trees, Random Forest, Support Vector Machines, Neural Networks, and Hidden Markov Models. However, generating revenue forecasts is a more difficult task than churn prediction. The prediction of game revenue, particularly how to estimate future revenue and create compensation models using time series prediction algorithms may require the use of predictive analytics, such as Support Vector Machines, Random Forest, Decision Trees, and Poison Trees. FIG. 20 is a diagram illustrating examples of data analysis techniques and models used to predict churn and/or revenue in a gaming context. As shown in the figure, game prediction (as shown in FIGS. 19 and 20), may include churn prediction and revenue prediction.

Embodiments may be used to improve player analytics for different game contents, use the game development analytics to maintain the balance of the in-game economy, and to use publishing analytics to extend the game lifetime cycle.

At present, knowledge sharing or standardization across different platforms does not exist. This is at least in part due to the confidential nature of data such as revenue, churn, and retention. This is also a reason why game analytics research is currently fragmented. Embodiments provide a platform to privately allow the sharing of this data without compromising the value or confidentiality of the game developer and player data.

Even though game analytics is widely used in the gaming industry, there is currently no standardized platform used to review, segment, and value player and gaming environment data. According to the traditional game value chain shown in FIG. 16, the game industry starts with game developers responsible for developing the games. When the game is ready, they find a game publisher to help with the publication stage. The publisher will publish the games through a game distributor and connect with potential players.

As mentioned, in game analytics, the gathered data is divided into roughly four categories: (1) game development analytics (player actions), (2) game publishing analytics (market size), (3) game distribution channel analytics (base of users), and (4) game player analytics, (actions within the game by unique player), as suggested by FIG. 17.

Game player analytics is an important aspect of the disclosed approach to monetizing game analytics. A feature of player analytics is analyzing the game behavior and specific preferences of players as a guide to improved game development. One kind of game player analytics is based on player segmentation, including the motivation of playing games and player game experience. Game development analytics includes verification of the gameplay, interface analytics, system analytics, process analytics, and performance analytics. Game publishing analytics focuses on player acquisition, retention, and revenue analytics. Channel analytics primarily focuses on analyzing the distribution channel's attributes and provides specific, solutions for game marketing and promotion.

Game metrics can be defined as the behavioral data source used for game analytics. Metrics can be variables, features, or calculated values. The relationship between game metrics and game analytics is that game metrics are the data used to track the game performance or development progress, Game analytics can use these metrics to identify trends and support decision making.

Game metrics 1802 can be divided into three categories, as shown in FIG. 18, These categories include player metrics 1804, process metrics 1808, and performance metrics 1808. Typically, player metrics focus on player behavior and customer research. Process metrics are used for game development process monitoring and management. Performance metrics have a relationship with the game technical monitoring, such as frame rate, number of bugs, and game client execution performance.

Game player analytics focuses on the player itself. Traditionally, player research uses qualitative methods and conduct surveys about player experience, satisfaction, and engagement. Most game player researchers use both qualitative and quantitative approaches and aim to identify patterns of player behavior and identify potential frustration points before players leave a game. Further, game data such as usability testing for playability, provides insight on how players play a game and what kind of behaviors they will perform during a game experience, such as a player's in-game progression. In addition, the game player analytics with the highest playtime metrics can be used for guiding game design and features.

Game designers not only need to focus on gameplay development, but also need to know who the potential players are likely to be and what their requirements are for a positive gaming experience. Game development typically needs to be performed to satisfy the requirements of different game players based on player segmentation. This will also make the marketing and promotion of a game more effective. In practice, to ensure a game is designed with consideration for the requirements of specific categories of players, segmentation is an effective way to identify different player groups. A goal of segmentation is to classify player groups and provide games more in line with player requirements. Players' needs for games are diverse, so the motivations for users to play games are diverse. Player segmentation can be used to target the motivation of different players during the game design process. In addition, game providers will develop different marketing strategies for different segments of garners.

FIG. 19 is a diagram illustrating the relationships between different types of analytics and data that may be used in game development, publishing, and distribution as part of valuing data and generating revenue. As shown in the figure, game analytics 1902 may be divided into data, metrics, and analytics of value within the game value chain 1904, and data, metrics, and analytics of value outside of (or orthogonal to) the game value chain 1906. As illustrated and described herein, the analytics that form part of the game value chain may include game player, game development, game publishing, and game distribution channel analytics. Further, game player analytics may be used for player segmentation and determination of player behaviors. Game development analytics may be used for gameplay, interface, system, process, and performance evaluation and development. Game publishing analytics may be used for acquisition, retention, and revenue efforts and projections.

Data, metrics, and analytics of value outside of (or orthogonal to) the game value chain 1906 may include game prediction and data visualization took, such as churn prediction models and revenue prediction models.

As an example, immersion is a useful indicator to guide and evaluate player behavior and motivation in games and can be used to perform more effective segmentation. Embodiments may assist in implementing adaptive games and gaming systems, in which game systems can be improved by player analytics. For example, analytics may suggest that a game's objectives result in players exploring only a fraction of the entire state space. Based on this result, developers may create a data-driven simulation solution for players to explore more space. Such an approach can also be used for more complex dynamical game systems.

Player behaviors include in-game actions and behaviors, such as navigation, and interaction with game objects and other in-game entities. Player behavior research involves specific in-game behaviors throughout the game experiences. One concept regards player behavior as simulacra (that is a representation of a scene or player), and based on this, the player is connected to models which interact with the different types of players. One example is the use of game hots based on a player's in-game behavior, especially those related to the designed purposes of a hot. This approach has the potential to distinguish between human player behaviors and automated program behaviors. In one embodiment cluster analysis and the application of clustering techniques to player behavioral data may be used as part of the disclosed system.

As a player, it is easy to generate many behavioral measures during a game playing session. Every time a player provides an input to the game system, it results in reactions and responses. However, accurate measures or understanding of player activities include quantities and metrics that need to be calculated in real-time. Data such as the position of a player's character, its health, stamina, character name, level, equipment, and currency, for example may all be useful in understanding a player's behavior during a game. In some cases, this information can be collected from the game client and game servers.

However, analyzing behavioral data from games can be challenging, especially for massively multiplayer games. Each of these games has thousands of simultaneously active players spread across hundreds of instances in the same virtual environment. Player behavior analysis based on instrumentation data and capture of quantitative information about player behavior within the virtual environment of digital games show the ability to model, understand, and predict future player behavior. Player focused research is also important for game publishing in providing guidance about game optimizations, improving game retention, delivering increased game revenue, and extending the life cycle of a game.

Game analytics has applications in game development, primarily to assist in the process of game development. It includes some technical performance and indicators of game development, such as bugs and crash monitors.

Acquisition analytics focuses on how to reduce the cost of attracting new users. It also considers how many new players enter a game, how many players finish a tutorial, and how much money is spent on user acquisition. To acquire more players, game developers usually first invest in the development and then authorize theft games for publishing on target platforms. A publisher often needs to acquire users by buying ads or by viral distribution on social networks.

Retention rate is an important indicator of the “stickiness” of games. This benchmark measures how players are engaged in a game and can also be used for evaluating game quality. At first, a retention rate is a factor in analyzing users' awareness of a brand. Then the concept of retention rate is applied to the game, especially in the analytics of player's retention in games. Mechanisms of player retention in massively multiplayer games focus on how to improve the in-game retention of players. Three key metrics may be considered; these are weekly playtime, stop rate, and how long respondents have been playing. These analytics show how the game data can be used to develop a powerful retention system.

The achievements of players within a game are significant to becoming an advanced player. However, once the players arrive at the highest game levels, social networking features have proven to be vital for game retention. This finding pointed out that social networks positively affected retention when individuals form interactions with partners of appropriate standards. Thus, there appear to be three motivational components that have a strong relationship with retention: achievement, social connection, and immersion.

With regards to mobile gaming, as most mobile games are free, players can download at any time and the revenue generated is from in-game purchases (IAP) or advertising. Classifier and regression models have been used to evaluate the impact of social interaction in casual games for a player's life-cycle. The results suggest that social activities are not associated with the trend towards becoming an advanced player, but social activities may improve game revenue.

Non-payment players (those who do not make in-game purchases) comprise the majority of freemium players, which leads to highly uneven purchases in mobile games. A key challenge for mobile game developers is to reduce the churn rate and increase players, not only by improving the retention rate, but also by considering the differences between junior players and senior players. A related goal is to increase a player's life-cycle value (LTV); this is motivated by the more recent increase in user acquisition costs for mobile applications. Considering the user acquisition costs and the market promotion fees, continuing to increase the game revenue is essential for game developers and publishers from the game industry side.

With regards to the various forms of data that may be acquired and processed, the following represent the primary types or categories of game related analytics:
Interface analytics—interactions which a player performs with the game interface and menus. This may be tracked by setting different game variables, such as mouse sensitivity, finger touch pressure, and monitor brightness. The data analytics of the interface is based on the premise that the menu and button settings can be recorded. Through the recorded data, the click volume of the interface icon and the validity of the design can be more effectively analyzed. Interface analytics has a relationship with how players interact with the game UI and also the in-game interface and system;
System analytics considers the actions from game engines and the sub-systems, such as an Artificial Intelligence (AI) system, in-game events, and Non-Player Character (NPC) actions. System analytics can be used to measure the effectiveness of a system design and provide guidance to a game developer regarding effective game system design. At present, system analytics focuses on in-game systems research and guidance regarding game development;
Game process analytics focuses on the game development process, provides monitoring of game development, and provides guidance regarding the game development process (such as using the agile development method to manage the development process).
Game process analysis can help developers improve game development efficiency, identify potential development problems, and resolve those problems effectively; and Performance analytics relates to the performance of game technical and the software-based infrastructure behind a game itself. It may include consideration of frame rate, the stability of the client execution, bandwidth, game build quality, and the number of game bugs found by QA testing.

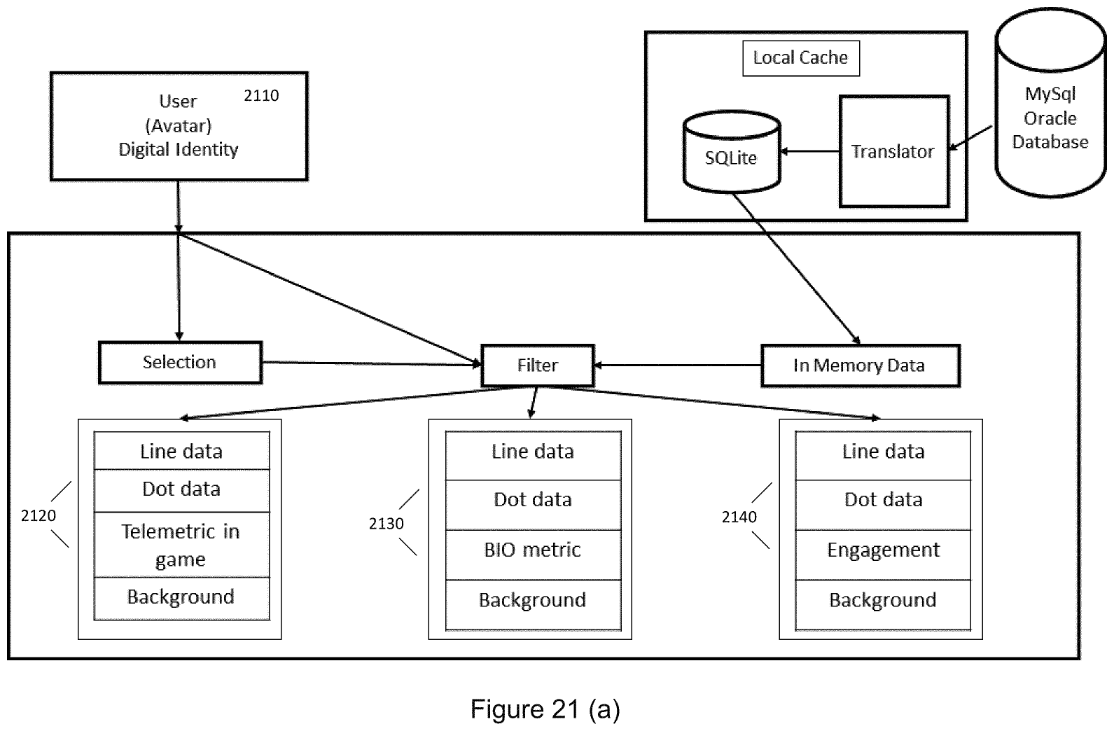

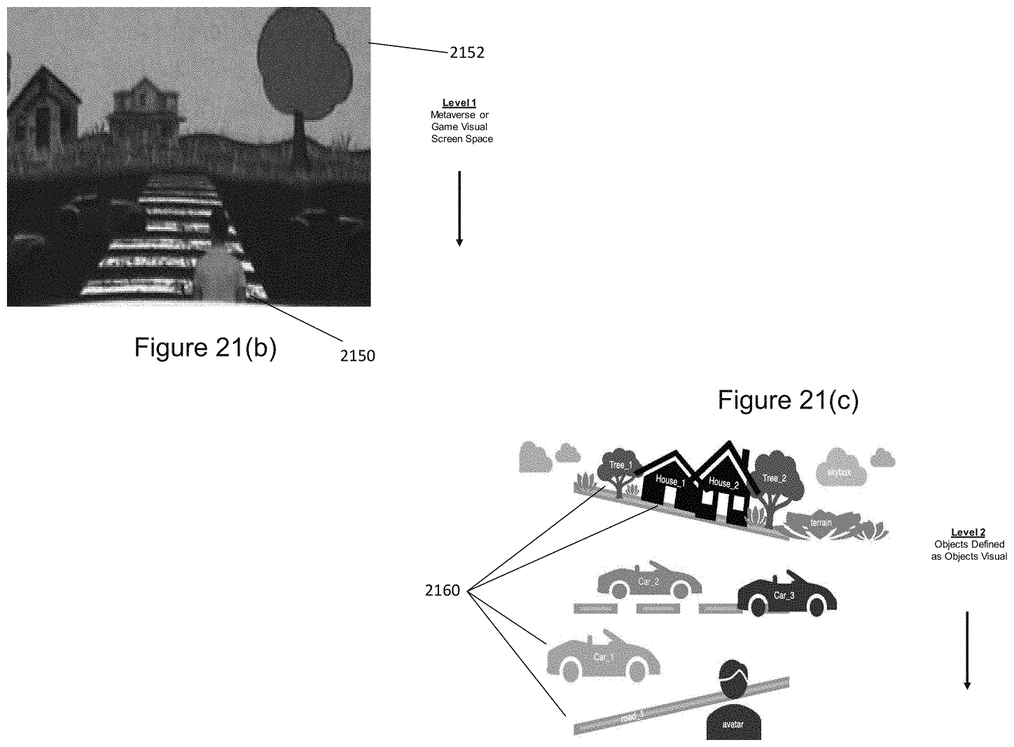

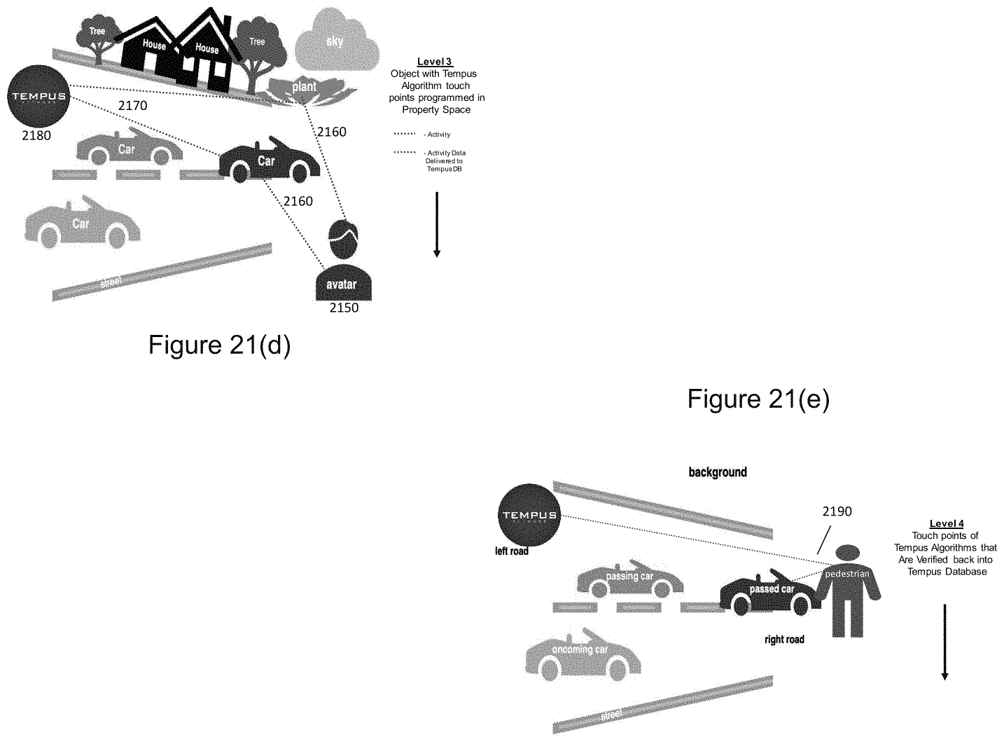

FIG. 21(a) is a diagram illustrating a data interface that may be used to collect data programmed into a WEB 3.0 or metaverse type setting, in accordance with an embodiment of the systems and methods disclosed herein. The interface is configured to connect to and access data from a pictorial representation of a Metaverse or Game visual screen or display, where each pixel in the screen or display is associated with data generated or created by an avatar (as suggested by element or component 2110 in the figure). The generated data is stored in a telemetric program (as suggested by element or component 2120), attributed to a BIO user ID related dataset (as suggested by element or component 2130), and valued and segmented into the engagement database (as suggested by element or component 2140). This processing enables the data generated by an avatar's actions and behaviors to be valued and also structured and used and to further train an AI engine associated with the Avatar.

FIGS. 21(b) through 21(e) are diagrams illustrating how a user's action and engagement in a gamified and/or metaverse environment for a specific task is processed by the Tempus network technology, in accordance with an embodiment of the systems and methods disclosed. In some embodiments, the disclosed system and methods operate to segment and value data generated or created by a user through their avatar, based on specific tasks that are completed or actions that are taken. This data is collected and granularly evaluated to verify and calculate the engagement value that should be attributed to a user. Once verified, this value compensates the user for their time and activity and is transferred to their digital wallet.

As an example, FIG. 21(b) shows an avatar (as indicated by element 2150) associated with a user in a screen or display of a metaverse or game space (as indicated by 2152). FIG. 21(c) illustrates how objects (as indicated by 2160) in the metaverse or game space may be defined and/or identified, as car, a road, a house, or terrain, as non-limiting examples. In some embodiments, the definition and/or identification may be performed by a trained model (such as an image classifier) and/or defined by the entity that is responsible for awarding the user with engagement derived compensation. FIG. 21 (d) illustrates how an avatar (2150) may interact with an object (2160) and data generated or created by the interaction (2170) is then acquired by the Tempus platform (2180). FIG. 21(e) illustrates how “touch points” representing situations, avatar actions, or avatar behaviors (2190) that may be responsible for generating engagement value may be recognized and stored in the system database as part of verifying the situation, avatar action, or avatar behavior and valuing user engagement and activities.

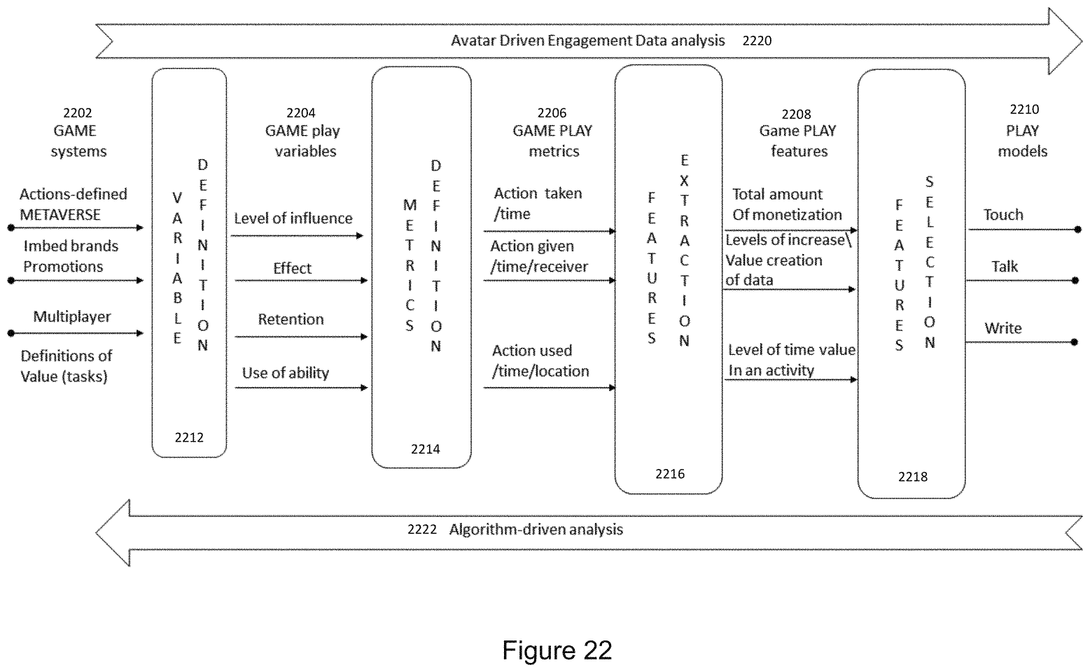

FIG. 22 is a diagram illustrating certain of the functions involved in the collection and analysis of engagement data in a gaming environment, and an example of the inputs or factors that may be part of each function, in accordance with some embodiments. As shown in the figure, in a gaming or virtual reality environment, a user's avatar will be a source of engagement related data and actions, as suggested by “Avatar Driven Engagement Data analysis” 2220.

Using a gaming environment as a non-limiting example, a game system 2202 may receive as an input or configuration parameter one or more of a set of defined actions, a set of embedded brands or promotional opportunities, an indication of single player or multiplayer mode, and definitions or descriptions of how a value is to be assigned to a task or achievement by a player. This information may then be used as part of defining variables for later stages of the data analysis, as suggested by process 2212.

Game play variables 2204 may include one or more of level of influence of a player, the effect of a player's actions or behaviors, the retention of a player (that is the continuing engagement of the player over time), and the effective use of the player's abilities in the gaming environment. These variables may be provided to a metrics definition process 2214.

The defined metrics 2206 may include one or more of an action taken at a specific time, an action given to another player at a specific time, and the recipient, and an action used at a specific time and/or location in the game or virtual environment. Note that in this context, an action may be the generation of an event, the performance of a task, a movement, or other game-related activity or behavior. The values of the game play metrics 2206 are provided to a feature extraction process 2216 to generate or extract game play features 2208.

Game play features 2208 may include one or more of the total value or amount of monetization generated by the player, the player's level or increase in creating value by their generated data, or the player's level or increase in creating value by their time spent engaged in the activity. The extracted features are provided to a feature selection process 2218 to generate play models 2210. The play models 2210 describe interactions with the gaming or virtual environment, and may include one or more of touch, talk (speech), or writing (data or text entry). As suggested by “Algorithm-driven analysis” 2222 in the figure, a player's actions, behaviors, and interactions may be used as part of the inputs to a model or other form of analysis that is used to generate a value of a player's data or other aspect of their engagement.

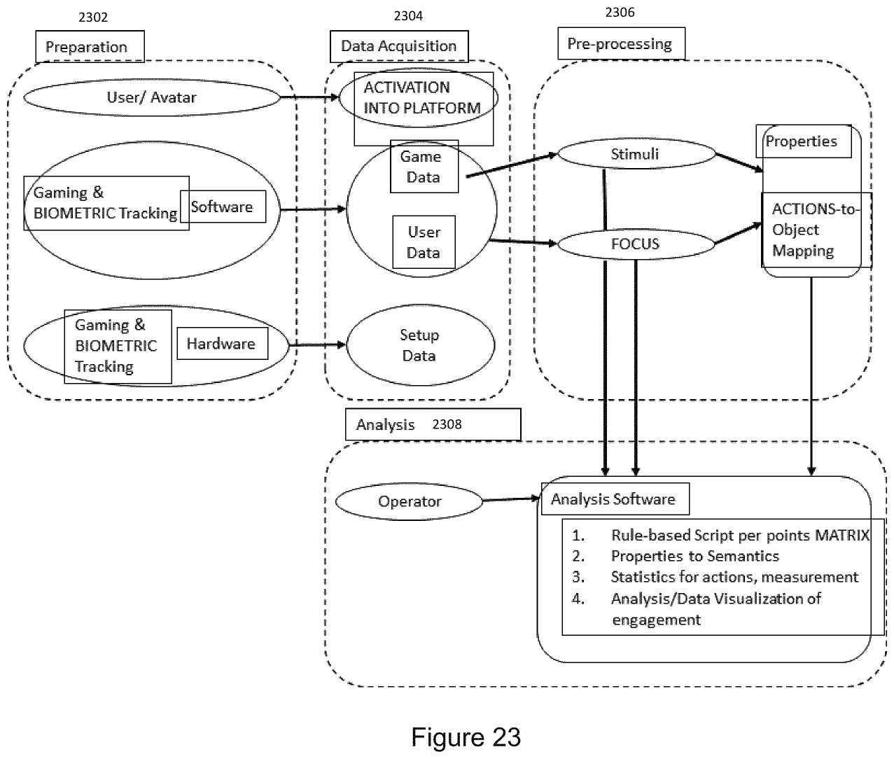

FIG. 23 is a diagram illustrating aspects of the data acquisition and pre-processing that may be part of an implementation of an embodiment. As shown in the figure, in a data preparation stage 2302, a user or player as represented by their avatar may register with an embodiment of the disclosed platform. Software and hardware elements may be used to acquire both game related and user related data. The software and/or hardware elements may be configured to track both game and biometric data of a user during gameplay.

Data acquisition stage 2304 may include acquiring data related to gameplay, the user/player, and the setup or configuration of the gaming or virtual environment. The acquired data may be pre-processed in pre-processing stage 2306 to identify stimuli received by the user/player and determine the user's/player's focus or attention during the gaming experience. The stimuli and/or focus may be assigned properties or characteristics and mapped objects.

The outputs of the pre-processing stage 2306 are provided to analysis stage 2308, where a set of instructions or rules may be used to convert or transform those outputs into values representing the monetization of the user's/player's actions and engagement with the game.

The disclosure includes the following clauses and embodiments:

1. A method of incentivizing a person to perform a task, comprising:

creating an incentive for the person to perform a task by enabling acquisition of one or more tokens as a reward for participating in or accomplishing the task;

providing the user with an engagement environment in which to acquire the one or more tokens;

acquiring data related to one or more of time spent, actions taken, or tasks performed by the user in the engagement environment;

determining an amount of tokens earned by the user based on the acquired data and a reputational status of the user;

storing the tokens earned by the user in a digital wallet associated with the user;

enabling the user to convert the tokens stored in the digital wallet into a native crypto-currency associated with the engagement environment; and

enabling the user to exchange the native crypto-currency into a local currency of the user.

2. The method of clause 1, further comprising enabling the user to exchange the native crypto-currency into a different crypto-currency.

3. The method of clause 1, further comprising implementing incentives for users to retain ownership of tokens to support a valuation of the native crypto-currency.

4. The method of clause 1, further comprising using a portion of tokens earned by one or more users to support a valuation of the native crypto-currency.

5. The method of clause 1, wherein the engagement environment is one of a single player game, a multi-player game, or a coordinated effort to accomplish a goal.

6. The method of clause 5, wherein the coordinated effort is one of a contest, an event, an effort to raise funds, or an effort to provide a service.

7. The method of clause 1, wherein determining the amount of tokens earned by the user further comprises determining a value of the impact of the user on the engagement or activities of other users with the engagement environment.

8. The method of clause 1, further comprising storing data regarding the time spent, actions taken, or tasks performed by the user in the engagement environment on a blockchain.

9. The method of clause 1, wherein the reputational status of the user is based on one or more of the tasks performed by the user, the impact of the user on others in the engagement environment, an indirect impact on others outside of the engagement environment, or the value of data created by the user.

10. The method of clause 1, further comprising receiving a payment from an entity in exchange for creating the incentive for the user to perform the task.

11. The method of clause 1, further comprising using a trained model to determine the amount of tokens earned by the user.

12. A system for incentivizing a person to perform a task, comprising:

one or more electronic processors configured to execute a set of computer-executable instructions; and

one or more non-transitory electronic data storage media containing the set of computer-executable instructions, wherein when executed, the instructions cause the one or more electronic processors to
create an incentive for the person to perform a task by enabling acquisition of one or more tokens as a reward for participating in or accomplishing the task;
provide the user with an engagement environment in which to acquire the one or more tokens;
acquire data related to one or more of time spent, actions taken, or tasks performed by the user in the engagement environment;
determine an amount of tokens earned by the user based on the acquired data and a reputational status of the user;
store the tokens earned by the user in a digital wallet associated with the user;
enable the user to convert the tokens stored in the digital wallet into a native crypto-currency associated with the engagement environment; and
enable the user to exchange the native crypto-currency into a local currency of the user.

13. The system of clause 12, wherein the instructions further cause the one or more electronic processors to enable the user to exchange the native crypto-currency into a different crypto-currency.

14. The system of clause 12, wherein the instructions further cause the one or more electronic processors to implement incentives for users to retain ownership of tokens to support a valuation of the native crypto-currency.

15. The system of clause 12, wherein the engagement environment is one of a single player game, a multi-player game, or a coordinated effort to accomplish a goal.

16. The system of clause 12, wherein the instructions further cause the one or more electronic processors to store data regarding the time spent, actions taken, or tasks performed by the user in the engagement environment on a blockchain.

17. The system of clause 12, wherein the instructions further cause the one or more electronic processors to use a trained model to determine the amount of tokens earned by the user.

18. A set of computer-executable instructions that when executed by one or more programmed electronic processors, cause the processors to:

create an incentive for the person to perform a task by enabling acquisition of one or more tokens as a reward for participating in or accomplishing the task;

provide the user with an engagement environment in which to acquire the one or more tokens;

acquire data related to one or more of time spent, actions taken, or tasks performed by the user in the engagement environment;

determine an amount of tokens earned by the user based on the acquired data and a reputational status of the user;

store the tokens earned by the user in a digital wallet associated with the user;

enable the user to convert the tokens stored in the digital wallet into a native crypto-currency associated with the engagement environment; and

enable the user to exchange the native crypto-currency into a local currency of the user.

19. The set of computer-executable instructions of clause 18, wherein the instructions further cause the one or more electronic processors to enable the user to exchange the native crypto-currency into a different crypto-currency, and wherein the engagement environment is one of a single player game, a multi-player game, or a coordinated effort to accomplish a goal.

20. The set of computer-executable instructions of clause 18, wherein the instructions further cause the one or more electronic processors to store data regarding the time spent, actions taken, or tasks performed by the user in the engagement environment on a blockchain.

21. The system of clause 12, wherein the instructions further cause the one or more electronic processors to use a portion of tokens earned by one or more users to support a valuation of the native crypto-currency.

22. The system of clause 15, wherein the coordinated effort is one of a contest, an event, an effort to raise funds, or an effort to provide a service.

23. The system of clause 12, wherein the instructions further cause the one or more electronic processors to determine the amount of tokens earned by the user further comprises determining a value of the impact of the user on the engagement or activities of other users with the engagement environment.

24. The system of clause 12, wherein the reputational status of the user is based on one or more of the tasks performed by the user, the impact of the user on others in the engagement environment, an indirect impact on others outside of the engagement environment, or the value of data created by the user.

25. The system of clause 12, wherein the instructions further cause the one or more electronic processors to receive a payment from an entity in exchange for creating the incentive for the user to perform the task.

26. The set of computer-executable instructions of clause 19, wherein the coordinated effort is one of a contest, an event, an effort to raise funds, or an effort to provide a service.

27. The set of computer-executable instructions of clause 18, wherein the instructions further cause the one or more electronic processors to determine the amount of tokens earned by the user further comprises determining a value of the impact of the user on the engagement or activities of other users with the engagement environment.

28. The set of computer-executable instructions of clause 18, wherein the instructions further cause the one or more electronic processors to receive a payment from an entity in exchange for creating the incentive for the user to perform the task.

29. The set of computer-executable instructions of clause 18, wherein the reputational status of the user is based on one or more of the tasks performed by the user, the impact of the user on others in the engagement environment, an indirect impact on others outside of the engagement environment, or the value of data created by the user.

30. The set of computer-executable instructions of clause 18, wherein the instructions further cause the one or more electronic processors to use a trained model to determine the amount of tokens earned by the user.

The disclosed system and methods can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method of incentivizing a person to perform a task, comprising:
creating an incentive for the person to perform a task by enabling acquisition of one or more tokens as a reward for participating in or accomplishing the task;
providing the user with an engagement environment in which to acquire the one or more tokens;
acquiring data related to one or more of time spent, actions taken, or tasks performed by the user in the engagement environment;
determining an amount of tokens earned by the user based on the acquired data and a reputational status of the user;
storing the tokens earned by the user in a digital wallet associated with the user;
enabling the user to convert the tokens stored in the digital wallet into a native crypto-currency associated with the engagement environment; and
enabling the user to exchange the native crypto-currency into a local currency of the user.

2. The method of claim 1, further comprising enabling the user to exchange the native crypto-currency into a different crypto-currency.

3. The method of claim 1, further comprising implementing incentives for users to retain ownership of tokens to support a valuation of the native crypto-currency.

4. The method of claim 1, further comprising using a portion of tokens earned by one or more users to support a valuation of the native crypto-currency.

5. The method of claim 1, wherein the engagement environment is one of a single player game, a multi-player game, or a coordinated effort to accomplish a goal.

6. The method of claim 5, wherein the coordinated effort is one of a contest, an event, an effort to raise funds, or an effort to provide a service.

7. The method of claim 1, wherein determining the amount of tokens earned by the user further comprises determining a value of the impact of the user on the engagement or activities of other users with the engagement environment.

8. The method of claim 1, further comprising storing data regarding the time spent, actions taken, or tasks performed by the user in the engagement environment on a blockchain.

9. The method of claim 1, wherein the reputational status of the user is based on one or more of the tasks performed by the user, the impact of the user on others in the engagement environment, an indirect impact on others outside of the engagement environment, or the value of data created by the user.

10. The method of claim 1, further comprising receiving a payment from an entity in exchange for creating the incentive for the user to perform the task.

11. The method of claim 1, further comprising using a trained model to determine the amount of tokens earned by the user.

12. A system for incentivizing a person to perform a task, comprising:
one or more electronic processors configured to execute a set of computer-executable instructions; and
one or more non-transitory electronic data storage media containing the set of computer-executable instructions, wherein when executed, the instructions cause the one or more electronic processors to
create an incentive for the person to perform a task by enabling acquisition of one or more tokens as a reward for participating in or accomplishing the task;
provide the user with an engagement environment in which to acquire the one or more tokens;
acquire data related to one or more of time spent, actions taken, or tasks performed by the user in the engagement environment;
determine an amount of tokens earned by the user based on the acquired data and a reputational status of the user;
store the tokens earned by the user in a digital wallet associated with the user;
enable the user to convert the tokens stored in the digital wallet into a native crypto-currency associated with the engagement environment; and
enable the user to exchange the native crypto-currency into a local currency of the user.

13. The system of claim 12, wherein the instructions further cause the one or more electronic processors to enable the user to exchange the native crypto-currency into a different crypto-currency.

14. The system of claim 12, wherein the instructions further cause the one or more electronic processors to implement incentives for users to retain ownership of tokens to support valuation of the native crypto-currency.

15. The system of claim 12, wherein the engagement environment is one of a single player game, a multi-player game, or a coordinated effort to accomplish a goal.

16. The system of claim 12, wherein the instructions further cause the one or more electronic processors to store data regarding the time spent, actions taken, or tasks performed by the user in the engagement environment on a blockchain.

17. The system of claim 12, wherein the instructions further cause the one or more electronic processors to use a trained model to determine the amount of tokens earned by the user.

18. A set of computer-executable instructions that when executed by one or more programmed electronic processors, cause the processors to:
create an incentive for the person to perform a task by enabling acquisition of one or more tokens as a reward for participating in or accomplishing the task;
provide the user with an engagement environment in which to acquire the one or more tokens;
acquire data related to one or more of time spent, actions taken, or tasks performed by the user in the engagement environment;
determine an amount of tokens earned by the user based on the acquired data and a reputational status of the user;
store the tokens earned by the user in a digital wallet associated with the user;
enable the user to convert the tokens stored in the digital wallet into a native crypto-currency associated with the engagement environment; and
enable the user to exchange the native crypto-currency into a local currency of the user.

19. The set of computer-executable instructions of claim 18, wherein the instructions further cause the one or more electronic processors to enable the user to exchange the native crypto-currency into a different crypto-currency, and wherein the engagement environment is one of a single player game, a multi-player game, or a coordinated effort to accomplish a goal.

20. The set of computer-executable instructions of claim 18, wherein the instructions further cause the one or more electronic processors to store data regarding the time spent, actions taken, or tasks performed by the user in the engagement environment on a blockchain.
